(19) United States
(12) Patent Application Publication
(10) Pub. No.: US 2008/0032913 A1
(43) Pub. Date: Feb. 7, 2008

(54) Masking of mineral oil odor and fragrancing of mineral oils

(75) Inventors: Anja Finke, Holzminden (DE); Jorg Eilers, Holzminden (DE); Falk Harzke, Bodenwerder (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: SYMRISE GMBH & CO. KG, Holzminden (DE)

(21) Appl. No.: 11/830,937

(22) Filed: Jul. 31, 2007

Related U.S. Application Data
(60) Provisional application No. 60/834,561, filed on Aug. 1, 2006.

(51) Int. Cl. C11B 9/00

(52) U.S. Cl. 512/6; 512/12; 512/17; 512/25; 512/27; 512/7; 512/8

(57) ABSTRACT

The invention relates to the field of masking mineral oil odor and the fragrancing of mineral oils. In this connection, the invention relates to a selection of particularly suitable odoriferous substances for masking a mineral oil odor and for fragrancing mineral oils. The invention furthermore relates to additives and to corresponding fragranced mineral oils themselves, in particular motor fuels and heating or lubricant oils.

This application claims the benefit under 35 U.S.C. §119(e) of provisional patent application Ser. No. 60/834,561, filed Aug. 1, 2006, the entire disclosure of which is hereby incorporated by reference.

### FIELD OF THE INVENTION

The invention relates to the field of masking mineral oil odor and the fragrancing of mineral oils. In this connection, the invention relates to a selection of particularly suitable odoriferous substances for masking a mineral oil odor and for fragrancing mineral oils. The invention furthermore relates to additives and to corresponding fragranced mineral oils themselves, in particular motor fuels and heating or lubricant oils.

### SUMMARY OF THE INVENTION

For the purposes of the present invention, a mineral oil is a mineral oil fraction generally produced from petroleum and is preferably liquid to highly viscous at 25° C. and 1013 hPa. Mineral oils for the purposes of the invention are in particular
motor fuels, in particular
gasoline, in particular gasoline to DIN EN 228,
kerosene and in particular aviation gasoline to ASTM D910 grade 100 LL or jet fuel such as Jet A-1 or Jet B, and
diesel, in particular to DIN EN 590, formerly DIN 51 601; and
oils, in particular
heating oil, in particular light and heavy oil and in particular to DIN 51603,
engine oil, gear oil, hydraulic oil, chain oil, cutting oil and lubricant oil.

Particularly preferred mineral oils are the “middle distillates” which, at standard pressure (1013 mbar), have a boiling range of 180 to 360° C., in particular heating oil EL to DIN 51603 and diesel fuel to DIN EN 590, heating oil to DIN 51601 part 1.

| Mineral oil | Boiling range | |
|---|---|---|
| fraction | (at 1013 mbar) | Use |
| Liquefied gas | below 30° C. | industrial and domestic heating gas |
| Petroleum ether | 40-70° C. | cleaning naphtha, solvent |
| Light gasoline | 60-100° C. | obtaining gasoline, |
| | | production of gases by cracking, |
| | | solvent |
| Medium gasoline | 70-150° C. | Carburetor fuel (gasoline) |
| | | solvent |
| Heavy gasoline | 120-180° C. | fuel for jet aircraft, |
| | | solvent |
| Kerosene | 150-280° C. | aviation turbine fuel |
| | | solvent, light heating oil |
| Gas oil | 200-360° C. | diesel fuel, heating oil |
| Residue | above 360° C. | by vacuum distillation: production of |
| | | engine oil, heavy heating oil |
| | | Remainder: bitumen (“tar”) |

A mineral oil odor is taken to be the odor emitted by higher-boiling unperfumed mineral oil fractions such as heating oil, diesel, gasoline, aviation gasoline, lubricant oil for engines or chains or cutting oil. This odor of mineral oil fractions (mineral oil odor), which is perceived by people as unpleasant, is hereinafter also described as a stench or malodor.

Masking of mineral oil odor is taken mean completely or partially covering up the mineral oil malodor, in particular of motor fuels, heating or lubricant oils, by an odoriferous substance or by an odoriferous substance mixture, such that the malodor impression is reduced or covered up. Masking, reducing or covering up the malodor of mineral oil has proved to be particularly difficult if the mineral oil is a heating oil, in particular a heating oil EL to DIN 51603, a heating oil to DIN 51601 part 1 and a diesel fuel to DIN EN 590, i.e. comprises a proportion of at least 90 wt. % and in particular of 95-99.9 wt. %, relative to the entire mineral oil, of a heating oil EL to DIN 51603, a heating oil to DIN 51601 part 1 and/or a diesel fuel to DIN EN 590.

Fragrancing or perfuming is taken to mean imparting an odor impression, in this case to mineral oils, i.e. an additional odor effect extending beyond the complete or partial covering up of the odor of mineral oil fractions; fragrancing accordingly goes beyond mere masking.

As widely defined, an odoriferous substance is here any substance which gives rise to an odorous impression or modifies the odorous perception of another substance. As more narrowly defined for the purposes of the present invention, an odoriferous substance is a substance which gives rise to an odorous impression (in humans).

An odoriferous substance mixture for the purposes of the invention is a mixture containing two or more odoriferous substances as narrowly or widely defined.

Additives are admixtures, active ingredients or active ingredient mixtures which, in motor or combustion fuels and lubricants, enhance desired properties, suppress unwanted properties or exert novel effects. For example, in the case of motor fuels, the engine intake system may be kept clean and deposits prevented in the engine or the ageing resistance of lubricant oils may be extended. Reducing exhaust gas pollutant emissions and preventing the corrosion of metal parts in the fuel system are further desired actions of additives.

Mineral oils which are preferred according to the invention contain substantially no substances with a boiling point of less than 120° C. at 1013 mbar. Preferred mineral oils are those in which at least 90 wt. %, particularly preferably at least 95 wt. % of the compounds contained therein have a boiling point in the range from 180-380° C. at 1013 mbar. Particularly preferred mineral oils are heating oil and diesel, in particular as stated above.

Mineral oils which are preferred according to the invention have a water content of at most 1 wt. %, preferably of at most 0.5 wt. %.

The sulfur content in mineral oils according to the invention preferably amounts to at most 500 mg/kg, preferably at most 200 mg/kg.

The proportion of mineral oil fractions according to the above table, in particular of heavy gasoline, kerosene and gas oil, in a mineral oil according to the invention amounts to at least 90 wt. %, particularly preferably 95 to 99.9 wt %, in each case relative to the entire mineral oil.

The odorization of gaseous combustion fuels, such as for example methane, or combustion fuels which have been converted into the liquid state under low pressures at 20° C., such as for example liquefied gas (LPG, liquefied petroleum gas), by the addition highly odoriferous substances acting as warning or alarm substances (odorizing agents) is known and a statutory requirement in many countries. Nowadays, due to their high degree of purity, these combustion fuels are, in themselves, virtually odorless. If leaks are not noticed in good time, explosive gas/air mixtures constituting a severe potential hazard quickly build up. For safety reasons, these combustion fuels are accordingly odorized by the addition of strongly smelling substances. The odorizing agents are still perceptible even when highly dilute and, due to their extremely unpleasant odor, are, as desired, associated with an alarm response in humans. An odorizing agent must not only have an unpleasant and mistakable odor, but above all must clearly constitute a warning odor.

In contrast, for the purposes of the present invention, the odoriferous substances or odoriferous substance mixtures are intended to impart to the mineral oil fractions a pleasant odor or at least to mask the malodor of the mineral oil fractions, but no warning odor is to be imparted. The mineral oil fractions of significance for the purposes of the present invention differ fundamentally from substantially odorless combustion fuels such as methane or LPG by having a characteristic intrinsic odor. Mineral oil fractions of significance for the purposes of the present invention furthermore differ from the above-stated combustion fuels with regard to their boiling point range or state of matter, such that the physical-chemical interactions between the mineral oil fractions under consideration here and the odoriferous substances or odoriferous substance mixtures incorporated therein and their release from the particular mineral oil fraction or their masking properties with regard to the odor of the mineral oil fraction differ from those in the above-stated combustion fuels.

JP-A 55-104393 describes that odorizing agents (i.e. substances which are intended to impart a warning odor, not a pleasant odor, to the fuel gas) containing an alkyne and at least 2 compounds selected from a group consisting of methyl acrylate, ethyl acrylate, methyl methacrylate, allyl methacrylate, ethyl propionate, methyl n-butyrate, methyl iso-butyrate and prenyl acrylate, and optionally tert.-butylmercaptan, are suitable for odorizing fuel gases. The quantity of odorizing agent is 50 ppm by weight (mg/kg of gas), preferably greater than or equal to 100 ppm. The best results for LPG were obtained with mixtures comprising tert.-butylmercaptan.

JP 59-185813 relates to covering up the odor of exhaust gases from a two-stroke engine. The solution presented therein provides feeding a lubricant oil provided with an aromatic perfume via a pump into the combustible motor fuel-air mixture and the resultant mixture is introduced into the cylinder, the lubricant oil provided with an aromatic perfume combusting only in part. The residual quantity of perfume present in the exhaust gas is then intended to cover up the exhaust gas odor. Conventional perfumes for use in cosmetic products etc. are considered suitable, while the quantity of perfume used amounts to approx. 1 wt. %, relative to the mass of the lubricant oil.

CN 1 049 176 describes the fragrancing of motor and combustion fuels such as LPG (Liquefied Petroleum Gas), gasoline and diesel by adding essences such as orange oil or jasmine oil, such that sweet-smelling motor and combustion fuels are obtained. The proportion of essences is in the range from 0.5-5 wt. %, relative to the total mass of the motor and combustion fuels.

JP 53-081634 describes a mixture of odoriferous substances which causes kerosene-like solvents to smell strongly unpleasant with the intention of preventing abuse thereof. With regard to odor, these additions of unpleasant smelling substances have the opposite effect to that intended for the purposes of the present invention.

EP 0 134 014 describes mineral oil compositions containing 2-70% of terpenes, such as pinene, cineole, limonene, dipentene, terpineols, menthol. As a result of the elevated proportion of odoriferous substances, the intention is to impart a more pleasant odor to the exhaust gases formed on combustion of these mineral oil compositions.

DE 1 037 668 describes lamp kerosene containing steppe grass oil.

EP 1 591 514 describes hydrocarbon compositions containing tricyclododecanes or tricyclododecenes, such as for example cycloverdol acetate.

U.S. Pat. No. 4,451,266 describes an additive for hydrocarbon mixtures such as gasoline or diesel, which additive, in addition to an alcohol with at most four C atoms, an aromatic hydrocarbon, a halogenated alkene, a hydroxy acid and a hydrocarbon fraction of a specific boiling range, also comprises 5 to 15 wt. % of an aliphatic ester which comprises at most 6 C atoms. Esters which are explicitly stated therein are: methyl acetate, ethyl acetate, propyl acetate, tert.-butyl acetate, methyl propionate, ethyl propionate, methyl n-butyrate, isopropyl acetate, methyl isobutyrate and mixtures thereof, wherein acetates, in particular propyl acetate, are preferred.

U.S. Pat. No. 4,353,710 describes extenders for hydrocarbon combustion fuels which are heavier than gasoline (for example middle distillates). Such extenders are characterized therein by the presence of a methoxy or ethoxy group, specifically from the class of ethers or esters. Representative examples of such extenders stated therein are methyl acetate, methyl propionate, methyl butyrate, ethyl acetate, ethyl propionate and ethyl butyrate. The proportion of the stated extenders typically amounts therein to 1-30 wt. %, preferably 5-25 wt. %, in particular around 20 wt. %, relative to the weight of the middle distillate.

WO 91/18961 describes esters having up to 25 C atoms, most preferably having 6 to 12 C atoms, as reodorants. The acid therein preferably comprises 1 to 4 C atoms, with C₄-C₁₀ esters of acetic acid, for example n-heptyl acetate or a 1:1 mixture of n-hexyl acetate and n-octyl acetate, being particularly preferred. It is furthermore generally explained therein that reodorants may also contain aldehydes, ketones, alcohols etc. in addition to these esters.

The use of amyl acetate for reodorizing hydrocarbons, specifically petroleum, is known from GB 10 772. A rate of addition of 10 g of amyl acetate per 1 L of petroleum is recommended therein.

GB 1 385 199 describes aerosol compositions which preferably contain 20-60 wt. % of a low molecular weight ketone such as acetone and 20-60 wt. % of petroleum ether with a boiling range of 30-40° C. For the purpose of leak detection, the aerosol compositions described therein preferably comprise a perfume containing hexanoic acid allyl ester, hexanoic acid ethyl ester, amyl acetate or furfurylmercaptan.

It has been found in the applicant's own tests that many alkane carboxylic acid alkyl esters such as for example amyl acetate (acetic acid n-pentyl ester), acetic acid ethyl ester, acetic acid n-butyl ester or acetic acid n-heptyl ester do not exhibit a satisfactory masking action with regard to mineral oil odor (see also the results listed in table 2 for odoriferous substances not to be used according to the invention). Compounds such as hexanoic acid allyl ester, benzyl acetate and ethylvanillin likewise did not exhibit an adequate masking action.

Previous odoriferous substance mixtures intended to enhance the odor of mineral oil fractions mainly fail adequately to cover up the mineral oil and/or heating oil odor. Moreover, not a few of these odoriferous substance mixtures, once incorporated in mineral oil fractions, in particular in the presence of additives, on exposure to (sun-)light, bring about severe discoloration, a tendency to separate (segregate) and/or haze.

Previous perfuming compositions, odoriferous substance mixtures and additives intended to enhance mineral oil fractions mainly fail adequately to cover up the mineral oil odor (malodor). Moreover, some of these mixtures exhibit severe discoloration of the additives on exposure to light.

### DETAILED DESCRIPTION OF THE INVENTION

In the light of the above-stated prior art, the primary object of the present invention was to provide alternative or improved odoriferous substance mixtures for masking mineral oil odor and/or for fragrancing mineral oil fractions, in particular middle distillates such as diesel or heating oil. The odoriferous substances should here satisfy as many as possible and preferably all of a series of requirements, in particular:
being ready available
being usable even in concentrated form, optionally as a constituent of an additive
being largely or completely colorless, including in the mineral oil fraction(s) and in relation to optionally added additives
exhibiting good solubility in mineral oil fractions
exhibiting elevated stability in the mineral oil fraction(s) to be odor masked and/or fragranced, in particular no discoloration and/or separation and/or haze should occur
exhibiting inert behavior towards the mineral oil fraction(s) and towards optionally added additives.

According to a first aspect, the stated object is achieved solved by a mineral oil, characterized in that the mineral oil comprises a proportion of 0.5 ppm to 1.2 wt. %, relative to the entire mineral oil, of one or more odoriferous substances which are selected from the group (A) consisting of

| Number | Name |
|---|---|
| 1 | 1,2,3,4,4a,9,10,10a-octahydro-phenanthrene-1-carboxylic |
| | acid methyl ester; 7-isopropyl-1,4a-dimethyl- |
| 2 | 1,3,5-trioxane; 2,4,6-trimethyl- |
| 3 | 1,3-benzodioxolane-5-propanal; alpha-methyl- |
| 4 | 1,3-dioxane; 2,4,6-trimethyl-4-phenyl- |
| 5 | 1,3-dioxolane-2-acetic acid ethyl ester; 2,4-dimethyl- |
| 6 | 1,3-dioxolane-2-acetic acid ethyl ester; 2-methyl- |
| 7 | 1,3-oxathiane; 2-methyl-4-propyl-(Z) |
| 154 | 1,6-octadien-3-ol; 3,7-dimethyl- |
| 8 | 10-undecenal |
| 9 | 1-butanol acetate; 3-methyl- |
| 10 | 1-decanol |
| 11 | 1H-4,7-methanoinden-5-ol propionate; 3a,4,5,6,7,7a- |
| | hexahydro- |
| 12 | 1-hexanol; 3,5,5-trimethyl- |
| 13 | 1-nonyne; 1,1-dimethoxy- |
| 14 | 1-octanol |
| 15 | 1-octen-3-ol acetate |
| 16 | 2(3H)-furanone; 4-hydroxy-2,5-dimethyl- |
| 152 | 2(3H)-furanone; 5-butyl-tetrahydro- |
| 17 | 2(3H)-furanone; 5-heptyl-dihydro- |
| 18 | 2(3H)-furanone; 5-hexyl-dihydro- |
| 19 | 2(3H)-furanone; dihydro-5-pentyl- |
| 20 | 2,2-dimethylpropanal; 3-(4-ethylphenyl)- |
| 21 | 2,4-decadienal (2E,4E) |
| 22 | 2,6-nonadienal (2E,6Z) |
| 23 | 2,6-octadien-1-ol; 3,7-dimethyl-(2E) |
| 24 | 2,6-octadien-1-ol acetate; 3,7-dimethyl-(2E) |
| 25 | 2,6-octadien-1-ol acetate; 3,7-dimethyl-(2Z) |
| 26 | 2,6-octadien-1-ol formate; 3,7-dimethyl-(2E) |
| 27 | 2,6-octadienal; 3,7-dimethyl-(2E) |
| 150 | 2,6-octadiene nitrile; 3,7-dimethyl-(2E) |
| 149 | 2,6-octadiene nitrile; 3,7-dimethyl-(2Z) |
| 28 | 2-butanone; 4-(2,6,6-trimethyl-1-cyclohexen-1-yl)- |
| 29 | 2-buten-1-ol acetate; 3-methyl- |
| 30 | 2-buten-1-one; 1-(2,6,6-trimethyl-1-cyclohexen-1-yl)-(E) |
| 31 | 2-buten-1-one; 1-(2,6,6,-trimethyl-3-cyclohexen-1-yl)-(E) |
| 32 | 2-cyclopenten-1-one; 3-methyl-2-(2-pentenyl)-(Z) |
| 33 | 2-decenal (2E) |
| 148 | 2H-1,5-benzodioxepin-3(4H)-one; 7-methyl- |
| 34 | 2H-1-benzopyran-2-one |
| 35 | 2-heptanol; 2,6-dimethyl- |
| 36 | 2-hexenal (2E) |
| 37 | 2H-pyran; 2-butyl-3,6-dihydro-4,6-dimethyl- |
| 38 | 2-naphthalenol; 1,2,3,4,4a,5,6,7-octahydro-2,6,6-trimethyl- |
| 39 | 2-nonene nitrile (2E) |
| 40 | 2-octanol; 2,6-dimethyl- |
| 61 | 2-octanol; 2,6-dimethyl- |
| 41 | 2-octanone |
| 42 | 2-pentenoic acid; 2-methyl- |
| 43 | 2-phenylethanol |
| 44 | 2-propen-1-ol; 3-phenyl-(E) |
| 45 | 2-propenal; 2-methyl-3-phenyl-(E) |
| 46 | 2-propenal; 3-phenyl-(E) |
| 156 | 2-propenoic acid ethyl ester; 3-phenyl-(E) |
| 47 | 2-propenoic acid phenyl methyl ester; 3-phenyl- |
| 48 | 2-tridecenal (2E) |
| 49 | 2-tridecene nitrile (2Z) |
| 50 | 3,6-nonadiene nitrile; 3,7-dimethyl- |
| 51 | 3-buten-2-one; 1-(2,4,4-trimethyl-2-cyclohexen-1-yl)-(2E) |
| 52 | 3-buten-2-one; 3-methyl-4-(2,6,6-trimethyl-2-cyclohexen-1-yl)- |
| 53 | 3-buten-2-one; 4-(2,6,6-trimethyl-1-cyclohexen-1-yl)- |
| 54 | 3-cyclohexene-1-carbaldehyde; 2,4,6-trimethyl- |
| 55 | 3-cyclohexene-1-carbaldehyde; 2,4-dimethyl-(Z) |
| 56 | 3-cyclohexene-1-carbaldehyde; 3-(4-methyl-3-pentenyl)- |
| 57 | 3-cyclohexene-1-carbaldehyde; 4-(4-hydroxy-4-methylpentyl)- |
| 58 | 3-cyclohexene-1-methanol acetate; alpha,alpha-4-trimethyl- |
| 59 | 3-hexen-1-ol (3E) |
| 60 | 3-hexen-1-ol (3Z) |
| 62 | 3-octanol; 3,7-dimethyl- |
| 63 | 4,7-methano-1H-indene-2,5-dimethanol; octahydro- |
| 64 | 4-decenal (4Z) |
| 65 | 4H-4a,9-methanoazuleno[5,6-d]-1,3-dioxole; octahydro- |
| | 2,2,5,8,8,9a-hexamethyl- |
| 66 | 5,9-undecadienal; 2,6,10-trimethyl- |
| 151 | 5-heptenal; 2,6-dimethyl- |
| 67 | 6-octen-1-ol; 3,7-dimethyl- |
| 68 | 6-octen-3-one; 2,4,4,7-tetramethyl- |
| 69 | 6-octenal; 3,7-dimethyl- |
| 70 | 6-octene nitrile; 3,7-dimethyl- |
| 71 | 7-octen-2-ol; 2,6-dimethyl- |
| 72 | 9-undecenal (9E) |
| 73 | 9-undecenal (9Z) |
| 74 | 9-undecenal; 2,6,10-trimethyl- |
| 75 | acetaldehyde; [(3,7-dimethyl-6-octenyl)oxy]- |
| 76 | benzaldehyde; 4-(1-methylethyl)- |
| 77 | benzaldehyde; 4-methyl- |
| 78 | benzoic acid 2-methylpropyl ester; 2-hydroxy- |
| 79 | benzoic acid 3-methylbutyl ester |
| 80 | benzoic acid ethyl ester |
| 81 | benzoic acid methyl ester; 2-(methylamino)- |
| 82 | benzoic acid n-pentyl ester, 2-hydroxy |
| 83 | benzoic acid n-propyl ester |
| 84 | benzene; (2,2-dimethoxyethyl)- |
| 85 | benzene; 1-(1,1-dimethylethyl)-3,5-dimethyl-2,4,6-trinitro- |
| 86 | benzene; 1,1′-methylenebis- |
| 87 | benzene; 1,4-dimethoxy- |
| 88 | bicyclo[2,2,1]heptane; 2,2-dimethyl-3-methylene- |
| 89 | bicyclo[2,2,1]heptan-2-ol; 1,3,3-trimethyl- |
| 90 | bicyclo[2,2,1]heptan-2-ol; 1,7,7-trimethyl- |
| 91 | bicyclo[3,1,1]hept-2-ene; 2,6,6-trimethyl- |
| 92 | butyric acid 2-phenylethyl ester; 3-methyl- |
| 93 | butyric acid 3-methylbutyl ester; 3-methyl- |
| 95 | butyric acid cyclohexyl ester |
| 96 | butyric acid ethyl ester |
| 97 | butyric acid ethyl ester; 2-methyl- |
| 153 | butyric acid ethyl ester; 3-methyl- |
| 98 | butyric acid ethyl ester; 3-oxo- |
| 94 | butyric acid n-butyl ester |
| 99 | quinoline; 6-(1-methylpropyl)- |
| 100 | cyclohexaneethanol acetate |
| 101 | cyclohexanol; 5-methyl-2-(1-methylethyl)- |
| 102 | cyclohexanol; 5-methyl-2-(1-methylethyl)- |
| 103 | cyclohexanol acetate |
| 104 | cyclohexanol acetate; 5-methyl-2-(1-methylethyl)- |
| 105 | cyclohexanone; 5-methyl-2-(1-methylethyl)-(iso) |
| 106 | cyclohexanone; 5-methyl-2-(1-methylethyl)-(L) |
| 107 | cyclohexanepropionic acid 2-propenyl ester |
| 108 | cyclohexene; 1-methyl-4-(1-methylethylidene)- |
| 109 | cyclopentaneacetic acid methyl ester; 3-oxo-2-pentyl-(E) |
| 110 | decanal |
| 111 | decanal; 2-methyl- |
| 112 | dodecanal |
| 113 | acetic acid 2-phenylethyl ester |
| 114 | acetic acid 2-propenyl ester; (cyclohexyloxy)- |
| 115 | acetic acid 2-propenyl ester; 2-(3-methylbutoxy)- |
| 116 | acetic acid 2-propenyl ester; phenoxy- |
| 117 | ethanone; 1-(1,2,3,4,5,6,7,8-octahydro-2,3,8,8-tetramethyl-2- |
| | naphthalenyl)- |
| 118 | ethanone; 1-(2,3,4,7,8,8a-hexahydro-3,6,8,8-tetramethyl-1H- |
| | 3a,7-methanoazulen-5-yl)- |
| 119 | ethanone; 1-(2-naphthalenyl)- |
| 120 | ethanone; 1-(2-pyrazinyl)- |
| 121 | ethanone; 1-(4-methylphenyl)- |
| 122 | ethanethioic acid S-[1-[2-(acetyloxy)ethyl]butyl] ester |
| 123 | heptanal |
| 124 | heptanoic acid ethyl ester |
| 125 | hexanal |
| 126 | hexanal; 3,5,5-trimethyl- |
| 127 | indeno[1,2-d]-1,3-dioxine; 4,4a,5,9b-tetrahydro- |
| 128 | indeno[1,2d]-1,3-dioxine; 4,4a,5,9b-tetrahydro-2,4-dimethyl- |
| 129 | methanone; diphenyl- |
| 130 | nonanal |
| 131 | octanal |
| 132 | octanoic acid ethyl ester |
| 155 | pentanoic acid ethyl ester; 2-methyl- |
| 133 | phenol; 2-methoxy-4-(2-propenyl)- |
| 134 | phenylacetaldehyde |
| 135 | phenylacetaldehyde; alpha-methyl- |
| 136 | phenylacetonitrile; alpha-cyclohexylidene- |
| 137 | phenylacetic acid 2-methylpropyl ester |
| 138 | phenylmethanol acetate; alpha-methyl- |
| 139 | propanedioic acid diethyl ester |
| 140 | propionic acid 2-phenoxyethyl ester; 2-methyl- |
| 141 | propionic acid hexyl ester; 2-methyl- |
| 142 | pyrazine; 2-ethoxy-1-(1-methylethyl)- |
| 143 | pyridine; 2-(3-phenylpropyl)- |
| 144 | pyridine; 4-(4,8-dimethyl-3,7-nonadienyl)- |
| 145 | thiobutyric acid 1-methylpropyl ester; 3-methyl- |
| 146 | undecanal |
| 147 | undecanal; 2-methyl- |

The odoriferous substances or odoriferous substance mixtures of group (A) to be used according to the invention are preferably formulated in an additive and added to a mineral oil fraction or mixture of two or more mineral oil fractions in order to form a mineral oil according to the invention. The odoriferous substances of group (A) have a masking action against unpleasant mineral oil odor and so ensure greater acceptance and finer quality of mineral oils containing these odoriferous substances. The odoriferous substances of group (A) have a masking action against unpleasant mineral oil odor, in particular against the malodor of diesel and heating oil. They are readily available, may also be used in concentrated form, are largely or completely colorless, readily soluble in mineral oils and further mineral oil additive constituents, very stable in the mineral oil(s) to be odor masked and/or fragranced, in particular no discoloration and/or separation and/or haze occurs, and they moreover cause no obvious troublesome reactions with mineral oils or further conventional mineral oil additive constituents.

Conventional commercial motor fuels or oils, such as for example diesel fuels or heating oils which according to the invention comprise one or more odoriferous substances of group (A), often contain conventional additives. A mineral oil according to the invention therefore preferably comprises, in a total concentration of 0.001 to 2 vol. %, relative to the total volume of the mineral oil, one or more further additive constituents selected from the group consisting of:
flow promoters (flow improvers, antisettling agents, for example in diesel fuel, Wax AntiSettling Additives (WASA), for example polyolefins, chlorinated polyethylenes, ethylene/propylene copolymers, low molecular weight copolymers such as ethylene/vinyl acetate copolymers),
filterability improvers (for example relatively high molecular weight chlorinated hydrocarbons such as for example condensation products of naphthalene and chlorinated paraffins, copolymers based on ethylene with in each case acrylic and methacrylic acid esters, maleic acid diesters, alcohols or vinyl acetate),
metal deactivators (usually chelating agents, for example 1,3-bis-(2-hydroxybenzylideneamino)propane=N,N′-disalicylidene-1,2-diaminopropane),
antioxidants (oxidation inhibitors, for example phenol derivatives such as p-aminophenol, 2,6-di-tert.-butyl-4-methylphenol (BHT), phenylenediamine, naphthalene derivatives such as naphthylamine, 1,3-bis-(2-hydroxybenzylideneamino)propane),
corrosion inhibitors (for example naphthenoic acid sodium salt, mixtures of (2-ethylhexyl)-(3-methylbutyl) phosphate and C₁₄-C₁₆ amines, 2-(2-(2-ethylhexyl)-phenoxyl)-1,1,2,2-tetraethoxyethanol, ethylenediamine dinonylnaphthalenesulfonate, mixtures of polymerized linoleic acid, polymerized methyllinoleic acid and organic phosphorus compounds, hydrazine, oleamides),
antifoam agents,
ignition accelerators (cetane number improvers, for example amyl nitrate, cyclohexyl nitrate, 2-ethylhexyl nitrate, nitrobenzene),
detergents (for example benzenesulfonic acid sodium salt, alkyl substituted succinimides such as for example polyisobutenyl succinic acid derivatives, alkyl substituted carbamides, polyisobuteneamines/polyisobutenepolyamines, amines),
particulate-reducing substances,
stabilizers (in particular for diesel and heating oil) (for example long-chain or cyclic amines such as N,N-dimethylcyclohexylamine),
antiknock agents (for example tert.-butyl alcohol, isobutyl alcohol, MTBE, ETBE, TAME, N-methylaniline, methanol),
carburetor antiicing additives (icing inhibitors, for example ethanol, isopropanol, dimethylformamide, dimethylacetamide, dipropylene glycol, diethylene glycol monomethyl ether, organic phosphorus compounds, glycerol esters of fatty acids, formamides, imidazolines),
antideposition agents (antipreignition agents, for example 1,2-dibromoethane, cresyl diphenyl phosphate, tricresyl phosphate, tricresyl phosphate, trimethyl phosphite, trichloroethyl phosphate, boric acid esters),
antismoke agents (combustion aids, smoke-reducing agents, for example barium naphthalenesulfonate, barium carbonate, lead naphthenate, tetraethyl lead, calcium sulfonate, manganese naphthenate, nickel carbonyl, methylcyclopentadienyl manganese tricarbonyl, ferrocene, butyl hydroperoxide, nitropropane, ethyl nitrate),
biocides,
lubricity improvers,
conductivity improvers (antistatic agents),
antiwear agents,
dyes,
color stabilizers, and
viscosity improvers.

An additive contained in the mineral oil according to the invention, in particular heating oil, diesel or gasoline, or usable for producing a mineral oil according to the invention preferably comprises, in addition to one or more odoriferous substances of group (A), at least one, preferably 2, 3, 4, 5, 6, 7 or all of the following constituents: flow promoters (WASA), lubricity improvers, antioxidants, ignition accelerators, antismoke agents, metal deactivators (chelating agents), stabilizers, detergents.

For producing an additive according to the invention or a mineral oil according to the invention, it may be of assistance for reasons of simpler apportioning or handling to add the odoriferous substance or odoriferous substances of group (A) to the additive or the mineral oil in the form of a mixture with one or more solvents or diluents. The solvent(s) or diluent(s) must here be compatible with the odoriferous substance(s) of group (A) and with the additives or the mineral oil fractions processed to yield the mineral oil according to the invention. Preferred solvents or diluents are here substances from one of the following groups L1 and L2 or a mixture of substances from both of groups L1 and L2 consisting of:

### (L1) isopropyl myristate, benzyl benzoate, diethyl phthalate and mixtures thereof,

### (L2) isododecane, n-paraffins with 9 to 14 C atoms, iso-paraffins with 9 to 14 C atoms, naphthalene, alkylnaphthalenes (in particular methylnaphthalenes) and mixtures thereof.

Solvents of group L2 are commercially obtainable, for example under the name Shellsol D60 or Shellsol D100 (defined mixtures of n- and iso-paraffins in the range from 9 to 14 C atoms) or Shellsol T (mixture of iso-paraffins).

One particular requirement when masking mineral oil odor is a low rate of addition of the odoriferous substance or the odoriferous substance mixture to the particular mineral oil. The concentration of odoriferous substances of group (A) preferably amounts in total to 1 to 1000 ppm, preferably 10 to 500 ppm and particularly preferably 30-300 ppm in heating oil, diesel and gasoline and 0.01-2 wt. %, preferably 0.1-2 wt. % and particularly preferably 0.2-2 wt. % in lubricant oils.

For the purposes of the present invention, advantageous mineral oils and additives are those with a number of at most 100 odoriferous substances which furthermore preferably comprise or consist of at most 80 odoriferous substances of group (A) to be used according to the invention. Preferred mineral oils and additives comprise at most 60 odoriferous substances, which furthermore preferably comprise or consist of at most 50 odoriferous substances of group (A) to be used according to the invention.

Particularly preferred mineral oils and additives comprise at most 30 odoriferous substances, which furthermore preferably comprise or consist of at most 3 to 30 odoriferous substances of group (A) to be used according to the invention.

The investigations carried out for the purposes of the present invention demonstrated that heating oil and lubricant oil is masked by a plurality of substances which differ greatly from this material. This was not to be expected in the light of U.S. Pat. No. 5,538,719, since, on the basis of the teaching therein, structurally similar compounds apparently effect mutual odor masking by means of cross-adaptation.

It has, however, now been found that, from among odoriferous substances of group (A), the odoriferous substances of the following group (B) are particularly suitable for reducing, masking or suppressing the stench of a mineral oil:

| Number | Name |
|---|---|
| 2 | 1,3,5-trioxane; 2,4,6-trimethyl- |
| 154 | 1,6-octadien-3-ol; 3,7-dimethyl- |
| 9 | 1-butanol acetate; 3-methyl- |
| 16 | 2(3H)-furanone; 4-hydroxy-2,5-dimethyl- |
| 152 | 2(3H)-furanone; 5-butyl-tetrahydro- |
| 19 | 2(3H)-furanone; dihydro-5-pentyl- |
| 23 | 2,6-octadien-1-ol; 3,7-dimethyl-(2E) |
| 27 | 2,6-octadienal; 3,7-dimethyl-(2E) |
| 150 | 2,6-octadiene nitrile; 3,7-dimethyl-(2E) |
| 149 | 2,6-octadiene nitrile; 3,7-dimethyl-(2Z) |
| 30 | 2-buten-1-one; 1-(2,6,6-trimethyl-1-cyclohexen-1-yl)-(E) |
| 148 | 2H-1,5-benzodioxepin-3(4H)-one; 7-methyl- |
| 36 | 2-hexenal (2E) |
| 156 | 2-propenoic acid ethyl ester; 3-phenyl-(E) |
| 151 | 5-heptenal; 2,6-dimethyl- |
| 67 | 6-octen-1-ol; 3,7-dimethyl- |
| 69 | 6-octenal; 3,7-dimethyl- |
| 70 | 6-octene nitrile; 3,7-dimethyl- |
| 75 | acetaldehyde; [(3,7-dimethyl-6-octenyl)oxy]- |
| 77 | benzaldehyde; 4-methyl- |
| 84 | benzene; (2,2-dimethoxyethyl)- |
| 153 | butyric acid ethyl ester; 3-methyl- |
| 103 | cyclohexanol acetate |
| 106 | cyclohexanone; 5-methyl-2-(1-methylethyl)-(L) |
| 107 | cyclohexanepropionic acid 2-propenyl ester |
| 110 | decanal |
| 116 | acetic acid 2-propenyl ester; phenoxy- |
| 117 | ethanone; 1-(1,2,3,4,5,6,7,8-octahydro-2,3,8,8-tetramethyl-2- |
| | naphthalenyl)- |
| 120 | ethanone; 1-(2-pyrazinyl)- |
| 121 | ethanone; 1-(4-methylphenyl)- |
| 123 | heptanal |
| 155 | pentanoic acid ethyl ester; 2-methyl- |
| 145 | thiobutyric acid 1-methylpropyl ester; 3-methyl- |

These odoriferous substances of group (B), which are a subset of group (A), have, as shown further below, the strongest action in reducing, masking or suppressing mineral oil malodor. They are therefore preferably used mineral oils in according to the invention, in particular in diesel and heating oil. A corresponding mineral oil particularly preferably contains two, three, four, five or more, preferably no more than 25, odoriferous substances of group (B).

A likewise preferred mineral oil according to the invention is one which contains, from among odoriferous substances of group (A), one or more odoriferous substances of the following group (C):

| Number | Name |
|---|---|
| 4 | 1,3-dioxane; 2,4,6-trimethyl-4-phenyl- |
| 5 | 1,3-dioxolane-2-acetic acid ethyl ester; 2,4-dimethyl- |
| 7 | 1,3-oxathiane; 2-methyl-4-propyl-(Z) |
| 13 | 1-nonyne; 1,1-dimethoxy- |
| 14 | 1-octanol |
| 18 | 2(3H)-furanone; 5-hexyl-dihydro- |
| 20 | 2,2-dimethylpropanal; 3-(4-ethylphenyl)- |
| 21 | 2,4-decadienal (2E,4E) |
| 22 | 2,6-nonadienal (2E,6Z) |
| 26 | 2,6-octadien-1-ol formate; 3,7-dimethyl-(2E) |
| 29 | 2-buten-1-ol acetate; 3-methyl- |
| 31 | 2-buten-1-one; 1-(2,6,6-trimethyl-3-cyclohexen-1-yl)-(E) |
| 33 | 2-decenal (2E) |
| 37 | 2H-pyran; 2-butyl-3,6-dihydro-4,6-dimethyl- |
| 38 | 2-naphthalenol; 1,2,3,4,4a,5,6,7-octahydro-2,6,6-trimethyl- |
| 39 | 2-nonene nitrile (2E) |
| 48 | 2-tridecenal (2E) |
| 49 | 2-tridecene nitrile (2Z) |
| 50 | 3,6-nonadiene nitrile; 3,7-dimethyl- |
| 52 | 3-buten-2-one; 3-methyl-4-(2,6,6-trimethyl-2-cyclohexen-1-yl)- |
| 54 | 3-cyclohexene-1-carbaldehyde; 2,4,6-trimethyl- |
| 55 | 3-cyclohexene-1-carbaldehyde; 2,4-dimethyl-(Z) |
| 59 | 3-hexen-1-ol (3E) |
| 60 | 3-hexen-1-ol (3Z) |
| 62 | 3-octanol; 3,7-dimethyl- |
| 64 | 4-decenal (4Z) |
| 65 | 4H-4a,9-methanoazuleno[5,6-d]-1,3-dioxole; octahydro- |
| | 2,2,5,8,8,9a-hexamethyl- |
| 72 | 9-undecenal (9E) |
| 73 | 9-undecenal (9Z) |
| 74 | 9-undecenal; 2,6,10-trimethyl- |
| 76 | benzaldehyde; 4-(1-methylethyl)- |
| 89 | bicyclo[2,2,1]heptan-2-ol; 1,3,3-trimethyl- |
| 90 | bicyclo[2,2,1]heptan-2-ol; 1,7,7-trimethyl- |
| 91 | bicyclo[3,1,1]hept-2-ene; 2,6,6-trimethyl- |
| 95 | butyric acid cyclohexyl ester |
| 96 | butyric acid ethyl ester |
| 97 | butyric acid ethyl ester; 2-methyl- |
| 99 | quinoline; 6-(1-methylpropyl)- |
| 105 | cyclohexanone; 5-methyl-2-(1-methylethyl)-(iso) |
| 111 | decanal; 2-methyl- |
| 112 | dodecanal |
| 114 | acetic acid 2-propenyl ester; (cyclohexyloxy)- |
| 115 | acetic acid 2-propenyl ester; 2-(3-methylbutoxy)- |
| 122 | ethanethioic acid S-[1-[2-(acetyloxy)ethyl]butyl] ester |
| 124 | heptanoic acid ethyl ester |
| 125 | hexanal |
| 126 | hexanal; 3,5,5-trimethyl- |
| 130 | nonanal |
| 131 | octanal |
| 133 | phenol; 2-methoxy-4-(2-propenyl)- |
| 134 | phenylacetaldehyde |
| 135 | phenylacetaldehyde; alpha-methyl- |
| 142 | pyrazine; 2-ethoxy-1-(1-methylethyl)- |
| 143 | pyridine; 2-(3-phenylpropyl)- |
| 144 | pyridine; 4-(4,8-dimethyl-3,7-nonadienyl)- |
| 146 | undecanal |
| 147 | undecanal; 2-methyl- |

These odoriferous substances of group (C) also have, in addition to a good malodor reduction value (see below for further details), a strong and pleasant intrinsic odor which can contribute to improving the acceptance of a mineral oil according to the invention. Accordingly, a corresponding mineral oil is preferred which contains two, three, four, five or more, preferably no more than 25, odoriferous substances of group (C).

Odoriferous substances of group (B) and (C), in particular in combination, exert a particularly good action in improving the odor of a mineral oil and in reducing, masking or suppressing the stench of a mineral oil. A mineral oil according to the invention therefore preferably contains at least one, preferably two, three, four, five or more and furthermore preferably up to 25 odoriferous substances of group (B) and at least one, preferably two, three, four, five or more and furthermore preferably up to 25 odoriferous substances of group (C).

A preferred mineral oil is furthermore one which, in addition to the one or more odoriferous substances of group (B) and/or (C), additionally contains one or more of the odoriferous substances of group (D) below:

| Number | Name |
|---|---|
| 1 | 1,2,3,4,4a,9,10,10a-octahydro-phenanthrene-1-carboxylic acid |
| | methyl ester; 7-isopropyl-1,4a-dimethyl- |
| 3 | 1,3-benzodioxolane-5-propanal; alpha-methyl- |
| 6 | 1,3-dioxolane-2-acetic acid ethyl ester; 2-methyl- |
| 8 | 10-undecenal |
| 10 | 1-decanol |
| 11 | 1H-4,7-methanoinden-5-ol propionate; 3a,4,5,6,7,7a-hexahydro- |
| 12 | 1-hexanol; 3,5,5-trimethyl- |
| 15 | 1-octen-3-ol acetate |
| 17 | 2(3H)-furanone; 5-heptyl-dihydro- |
| 24 | 2,6-octadien-1-ol acetate; 3,7-dimethyl-(2E) |
| 25 | 2,6-octadien-1-ol acetate; 3,7-dimethyl-(2Z) |
| 28 | 2-butanone; 4-(2,6,6-trimethyl-1-cyclohexen-1-yl)- |
| 32 | 2-cyclopenten-1-one; 3-methyl-2-(2-pentenyl)-(Z) |
| 34 | 2H-1-benzopyran-2-one |
| 35 | 2-heptanol; 2,6-dimethyl- |
| 40 | 2-octanol; 2,6-dimethyl- |
| 61 | 2-octanol; 2,6-dimethyl- |
| 41 | 2-octanone |
| 42 | 2-pentenoic acid; 2-methyl- |
| 43 | 2-phenylethanol |
| 44 | 2-propen-1-ol; 3-phenyl-(E) |
| 45 | 2-propenal; 2-methyl-3-phenyl-(E) |
| 46 | 2-propenal; 3-phenyl-(E) |
| 47 | 2-propenoic acid phenyl methyl ester; 3-phenyl- |
| 51 | 3-buten-2-one; 1-(2,4,4-trimethyl-2-cyclohexen-1-yl)-(2E) |
| 53 | 3-buten-2-one; 4-(2,6,6-trimethyl-1-cyclohexen-1-yl)- |
| 56 | 3-cyclohexene-1-carbaldehyde; 3-(4-methyl-3-pentenyl)- |
| 57 | 3-cyclohexene-1-carbaldehyde; 4-(4-hydroxy-4-methylpentyl)- |
| 58 | 3-cyclohexene-1-methanol acetate; alpha,alpha-4-trimethyl- |
| 63 | 4,7-methano-1H-indene-2,5-dimethanol; octahydro- |
| 66 | 5,9-undecadienal; 2,6,10-trimethyl- |
| 68 | 6-octen-3-one; 2,4,4,7-tetramethyl- |
| 71 | 7-octen-2-ol; 2,6-dimethyl- |
| 78 | benzoic acid 2-methylpropyl ester; 2-hydroxy- |
| 79 | benzoic acid 3-methylbutyl ester |
| 80 | benzoic acid ethyl ester |
| 81 | benzoic acid methyl ester; 2-(methylamino)- |
| 82 | benzoic acid n-pentyl ester, 2-hydroxy |
| 83 | benzoic acid n-propyl ester |
| 85 | benzene; 1-(1,1-dimethylethyl)-3,5-dimethyl-2,4,6-trinitro- |
| 86 | benzene; 1,1′-methylenebis- |
| 87 | benzene; 1,4-dimethoxy- |
| 88 | bicyclo[2,2,1]heptane; 2,2-dimethyl-3-methylene- |
| 92 | butyric acid 2-phenylethyl ester; 3-methyl- |
| 93 | butyric acid 3-methylbutyl ester; 3-methyl- |
| 98 | butyric acid ethyl ester; 3-oxo- |
| 94 | butyric acid n-butyl ester |
| 100 | cyclohexaneethanol acetate |
| 101 | cyclohexanol; 5-methyl-2-(1-methylethyl)- |
| 102 | cyclohexanol; 5-methyl-2-(1-methylethyl)- |
| 104 | cyclohexanol acetate; 5-methyl-2-(1-methylethyl)- |
| 108 | cyclohexene; 1-methyl-4-(1-methylethylidene)- |
| 109 | cyclopentaneacetic acid methyl ester; 3-oxo-2-pentyl-(E) |
| 113 | acetic acid 2-phenylethyl ester |
| 118 | ethanone; 1-(2,3,4,7,8,8a-hexahydro-3,6,8,8-tetramethyl- |
| | 1H-3a,7-methanoazulen-5-yl)- |
| 119 | ethanone; 1-(2-naphthalenyl)- |
| 127 | indeno[1,2-d]-1,3-dioxine; 4,4a,5,9b-tetrahydro- |
| 128 | indeno[1,2d]-1,3-dioxine; 4,4a,5,9b-tetrahydro-2,4-dimethyl- |
| 129 | methanone; diphenyl- |
| 132 | octanoic acid ethyl ester |
| 136 | phenylacetonitrile; alpha-cyclohexylidene- |
| 137 | phenylacetic acid 2-methylpropyl ester |
| 138 | phenylmethanol acetate; alpha-methyl- |
| 139 | propanedioic acid diethyl ester |
| 140 | propionic acid 2-phenoxyethyl ester; 2-methyl- |
| 141 | propionic acid hexyl ester; 2-methyl- |

These odoriferous substances likewise have a good malodor reduction value and are furthermore distinguished in that, in mineral oils, they harmoniously round off the odor brought about by the odoriferous substances of group (B) and/or (C). A mineral oil according to the invention therefore preferably contains
at least one, preferably two, three, four, five or more and odoriferous substances of group (B) and/or (C), and
at least one, preferably two, three, four, five or more and furthermore preferably up to 25 odoriferous substances of group (D).

In additives according to the invention, the total mass of odoriferous substances of group (A) preferably accounts for a proportion of 0.5 to 80 wt. %, preferably 2 to 50 wt. %, preferably 3 to 30 wt. %, in each case relative to the total weight of the additive.

For technical reasons, it is often desired to use only a small number of odoriferous substances which are active against unpleasant mineral oil odor. It is therefore preferred for the number of odoriferous substances from group (A), in particular from group (B), (C) and/or (D), in a mineral oil or additive according to the invention to amount from 2 to 50, with a number of odoriferous substances to be used according to the invention of 3 to 30 being particularly preferred, in each case relative to the entire mixture of odoriferous substances of group (A) in the mineral oil or additive.

For perfumery and hedonistic reasons, it is often necessary additionally to use a, in the present case small, proportion of odoriferous substances which are less active against mineral oil odor. Further odoriferous substances may therefore additionally be present in the mineral oil or additive in addition to the odoriferous substances of group (A), in particular of groups (B), (C) and/or (D). However, as described above, the overall total number of odoriferous substances in a mineral oil according to the invention should amount to no more than 100.

The above described preferably low rate of addition of odoriferous substances in mineral oils according to the invention entails particularly active odoriferous substances and odoriferous substance mixtures, such that these should preferably be composed of a not excessively large number of particularly active odoriferous substances. The possibility of additive discoloration in particular presents a difficulty. Such discoloration may for example be triggered by an excessively high concentration of vanillin, ethylvanillin, maltol and/or ethylmaltol in the perfuming composition. Vanillin is active against an unpleasant mineral oil odor, but may lead to severe discoloration in the additive. Vanillin, ethylvanillin, maltol and/or ethylmaltol should therefore be present in only the smallest possible quantities or be entirely absent from an additive for masking, reducing or suppressing malodor.

A mineral oil or additive according to the invention preferably comprises at least one, two three or more, preferably at most ten, further odoriferous substances (which are thus not part of the odoriferous substances of group (A) to be used according to the invention) with a vapor pressure of greater than or equal to 0.1 Pa at 25° C., preferably with a vapor pressure of greater than or equal to 0.5 Pa at 25° C., particularly preferably with a vapor pressure of greater than or equal to 1 Pa at 25° C.

Examples of further odoriferous substances which may be a constituent of an additive according to the invention or a mineral oil according to the invention may be found, for example, in S. Arctander, Perfume and Flavor Chemicals, vol. I and II, Montclair, N.J., 1969, private publication or K. Bauer, D. Garbe and H. Surburg, Common Fragrance and Flavor Materials, 4^{th} ed., Wiley-VCH, Weinheim 2001.

Since essential oils generally comprise a plurality (often far in excess of 100 compounds) of odoriferous substances, which in some cases make no (appreciable) contribution to malodor masking due their low content in the essential oil, the total proportion of essential oils in mineral oils and additives according to the invention is preferably at most 25 wt. %, preferably at most 15 wt. %, further preferably at most 7 wt. %, relative to the total quantity of odoriferous substances of group (A) in the mineral oil or additive. In a particularly preferred embodiment, additives and mineral oil fractions according to the invention contain no essential oils, especially since some essential oils may result in discoloration, separation and/or haze in additives and mineral oil fractions according to the invention.

An advantageous mineral oil or additive according to the invention is one which comprises a total proportion of less than 8 wt. % of vanillin, ethylvanillin, maltol and/or ethylmaltol, relative to the total mass of odoriferous substances of group (A). A preferred mineral oil or additive according to the invention is one which comprises a total proportion of less than 4 wt. %, particularly preferably of less than 1.5 wt. %, of vanillin, ethylvanillin, maltol and/or ethylmaltol, relative to the total mass of odoriferous substances of group (A). These limits apply in particular to heating oil and diesel.

A particularly advantageous mineral oil or additive according to the invention is one having a proportion of less than 8 wt. % of vanillin relative to the entire quantity of odoriferous substances of group (A). A preferred mineral oil and additive according to the invention is one which comprises a proportion of less than 4 wt. % and particularly preferably of less than 1.5 wt. % of vanillin relative to the total quantity of odoriferous substances of group (A) in the mineral oil or additive. These limits apply in particular to heating oil and diesel.

Thanks to the use of mixtures of the stated odoriferous substances of group (A) and in particular of groups (B) and (C), a product may be perfumed in such a manner that a weak fragrance is perceived, while the presence of the unpleasant odor of mineral oil fractions is simultaneously suppressed. Strong perfuming of elevated intensity is not necessary in order to achieve the desired effect.

Perfuming compositions and odoriferous substance compositions are occasionally used for masking an unpleasant mineral oil odor. The development of such odoriferous substance compositions and the verification of their effectiveness in masking mineral oil odor has in the past proceeded by trial and error. Conventionally, a sample of an odoriferous substance or odoriferous substance mixture which is to be investigated for its mineral oil odor masking ability (masking sample) is mixed with a sample of the mineral oil fraction (malodor standard) to be masked and the resultant odor impression is determined olfactorily by a panel of testers. Accordingly, development of an odoriferous substance or odoriferous substance mixture which masks a mineral oil odor is at present a complex procedure.

The present invention therefore also provides a test method for verifying masking of mineral oil odor by a test sample comprising one or more odoriferous substances, comprising the steps:
a) producing a malodor standard mixture containing mineral oil in an odorless carrier gas,
b) producing a test mixture containing a mineral oil fraction and a test sample in the carrier gas, and
c) determining the overall intensity and/or malodor impression of the malodor standard mixture in comparison with the test mixture.

The intensity of a substance or substance mixture describes the intensity of the mixture perceived olfactorily by trained testers, irrespective of the quality of the odor as a stench or pleasant odor. The stronger a substance or substance mixture smells, the higher is the intensity value. Intensity is here rated on a scale from 1 to 9. A value of 1 means odorless, while 9 means very strong smelling. In turn, the malodor impression describes the intensity of the perceived stench. In the present case, the term malodor reduction value describes the difference in intensity, i.e. the difference in the stench (malodor) of the malodor standard mixture and the test mixture.

The test method is preferably carried out at 20° C. and 1013 mbar. It is likewise preferred for the concentration of heating oil in the malodor standard mixture and the test mixture to be equally high. This permits particularly good comparison of the mixtures.

The test sample according to the invention preferably comprises one or more odoriferous substances. In this manner, relatively complex odoriferous substance mixtures, such as for example combinations of odoriferous substances and essential oils, may also be verified for their suitability for masking mineral oil odor.

The test method according to the invention is preferably carried out using a defined quantity of a mineral oil fraction.

For carrying out the test method according to the invention, it is additionally preferred for the concentration of the malodor standard heating oil in the test and/or malodor standard mixture to amount to at least 0.1 μl/l, preferably 0.1 to 1 μl/l and particularly preferably 0.3 to 0.8 μl/l. At this concentration, the stench of the malodor standard is already readily perceptible, but without the tester's sense of smell being largely overwhelmed by the malodor standard. This concentration then also does not impair the tester's cognitive ability or wellbeing if many (10-30) test samples are assessed in quick succession. These concentrations may particularly readily be established by vaporizing 5 μl of the mineral oil Fraction to be investigated in 7 l of air.

The test method is particularly preferably carried out by the individual test samples being tested for suitability for covering up a mineral oil odor in containers of an identical size. The individual test samples are here in each case assessed by at least 8 (expert) testers by smelling in comparison with a sample comprising only the mineral oil fraction (malodor standard). This malodor standard without odoriferous substance is preassigned an intensity of 6. Odor intensities are rated on a scale from 1, which corresponds to “odorless”, to 9, which corresponds to “very strong”. The reduction value is calculated by deducting the intensity of the standard from the mean odor intensity of the malodor. The testers are selected on the basis of their ability to assess the strength of odors reproducibly. Before the test series, the testers are trained to recognize the mineral oil odor.

As an alternative to the test method which has just been described, the odoriferous substance or odoriferous substance mixture to be tested is incorporated into the mineral oil fraction in question in a concentration of 50 ppm.

20 μl of the mineral oil fraction in question (reference sample), on the one hand, and 20 μl of the mineral oil fraction in question containing 50 ppm of the odoriferous substance or odoriferous substance mixture to be investigated, on the other hand, are introduced (generally pipetted centrally onto the bottom of the jar or beaker) at room temperature (approx. 20° C.) into two separate jars or beakers (each of a volume 200 ml). After 1 minute, both jars or beakers are evaluated in direct comparison with regard to odor by six trained testers.

Odor is evaluated in both cases using the following evaluation scale from 1-6:

1=no difference relative to reference sample
2=slight difference relative to reference sample
3=discernible difference relative to reference sample
4=distinct difference relative to reference sample
5=distinct difference relative to reference sample, odoriferous substance (mixture) is discernible
6=distinct difference relative to reference sample, odoriferous substance (mixture) is distinctly discernible

In particularly preferred embodiments of the invention, the odoriferous substances or odoriferous substance mixtures to be used according to the invention and the test sample found according to the invention containing one or more odoriferous substances may be combined with perfume oils.

Accordingly, the invention also provides a method for producing a mineral oil odor masking additive comprising the steps:

a) selecting a test mixture as previously described according to the invention,
b) preparing the additive containing the odoriferous substance(s) of the selected test mixture in an adequate concentration for masking mineral oil.

The invention additionally provides a mineral oil odor masking additive produced using a production method according to the invention.

Odoriferous substances of group (A) to be used according to the invention or an odoriferous substance mixture to be used according to the invention comprising 2, 3, 4, 5, 6, 7, 8, 9, 10 or more odoriferous substances of group (A) exhibit a malodor reduction value of greater than or equal to 2.3.

Preferred odoriferous substances of group (A) to be used according to the invention or an odoriferous substance mixture to be used according to the invention comprising 2, 3, 4, 5, 6, 7, 8, 9, 10 or more odoriferous substances of group (A) are those which exhibit a malodor reduction value of greater than or equal to 3.0, more preferably a malodor reduction value of greater than or equal to 3.5.

### EXAMPLES

### Example 1

### 1. Selection and Training of Testers

A. The testers must be capable of distinguishing the odor of heating oil from an odorless solvent (dipropylene glycol=DPG).

To this end, several paperboard smell strips are dipped in heating oil. In addition, several smell strips are dipped in DPG. Only those testers who are capable of distinguishing the smell strips without error in a test sequence heating oil-heating oil-DPG and DPG-DPG-heating oil take part in the further testing.

B. Various concentrations of the heating oil are then introduced into a defined volume of air. The testers sort the samples by intensity, i.e. strength of odor. The testers must correctly recognize and evaluate the sequence of concentrations. Those testers who have passed both tests may participate in the raw material test described below.

### 3. Raw Material Test for Mineral Oil Odor in Diesel or Heating Oil

The investigated odoriferous substances are individual odoriferous substances (in some cases, they may also comprise mixtures of (E) and (Z) isomers or also of stereoisomers). The odoriferous substances are evaluated by the selected testers in a defined gaseous sample with regard to intensity and residual strength of the diesel or heating oil odor.

Not all of the odoriferous substances are equally soluble in mineral oil fractions. Therefore, before sample preparation, 30 μl of odoriferous substance and 150 μl of the diesel or heating oil are in each case mixed. 6 μl of the oil phase are placed in an air-filled vessel of a capacity of 7 l. The samples are kept at room temperature (approx. 20° C.) for 15 h before evaluation. The individual samples are in each case evaluated by at least 8 testers by smelling in comparison with a sample solely comprising 5 μl of diesel or heating oil. The mean of the at least 8 values obtained for the particular raw material is then calculated.

Reference is made to the above-stated definitions and explanations with regard terminology and the evaluation scale.

As has been found, the solvents Solutol A (2-(2-ethoxyethoxy)ethanol) and dipropylene glycol (DPG) have no influence on the intensity of the stench or the total intensity. These solvents may thus be used in place of the remaining constituents of a perfuming composition which are not being tested here. The odoriferous substances of group (A) listed in Table 1 exhibited very similar results for diesel or heating oil.

TABLE 1
Malodor reduction values of raw materials of group
(A) to be used according to the invention

| | Re- | |
|---|---|---|
| | duc- | |
| | tion | |
| No. | value | Name |
| 1 | 3.0 | 1,2,3,4,4a,9,10,10a-octahydro-phenanthrene-1-carboxylic |
| | | acid methyl ester; 7-isopropyl-1,4a-dimethyl- |
| 2 | 3.6 | 1,3,5-trioxane; 2,4,6-trimethyl- |
| 3 | 2.6 | 1,3-benzodioxolane-5-propanal; alpha-methyl- |
| 4 | 2.5 | 1,3-dioxane; 2,4,6-trimethyl-4-phenyl- |
| 5 | 3.2 | 1,3-dioxolane-2-acetic acid ethyl ester; 2,4-dimethyl- |
| 6 | 3.5 | 1,3-dioxolane-2-acetic acid ethyl ester; 2-methyl- |
| 7 | 2.7 | 1,3-oxathiane; 2-methyl-4-propyl-(Z) |
| 8 | 3.4 | 10-undecenal |
| 9 | 3.9 | 1-butanol acetate; 3-methyl- |
| 10 | 2.4 | 1-decanol |
| 11 | 2.5 | 1H-4,7-methanoinden-5-ol propionate; 3a,4,5,6,7,7a- |
| | | hexahydro- |
| 12 | 2.7 | 1-hexanol; 3,5,5-trimethyl- |
| 13 | 2.9 | 1-nonyne; 1,1-dimethoxy- |
| 14 | 2.7 | 1-octanol |
| 15 | 2.8 | 1-octen-3-ol acetate |
| 16 | 3.9 | 2(3H)-furanone; 4-hydroxy-2,5-dimethyl- |
| 17 | 3.2 | 2(3H)-furanone; 5-heptyl-dihydro- |
| 18 | 3.3 | 2(3H)-furanone; 5-hexyl-dihydro- |
| 19 | 4.0 | 2(3H)-furanone; dihydro-5-pentyl- |
| 20 | 2.7 | 2,2-dimethylpropanal; 3-(4-ethylphenyl)- |
| 21 | 2.3 | 2,4-decadienal (2E,4E) |
| 22 | 3.5 | 2,6-nonadienal (2E,6Z) |
| 23 | 4.5 | 2,6-octadien-1-ol; 3,7-dimethyl-(2E) |
| 24 | 2.3 | 2,6-octadien-1-ol acetate; 3,7-dimethyl-(2E) |
| 25 | 2.3 | 2,6-octadien-1-ol acetate; 3,7-dimethyl-(2Z) |
| 26 | 2.5 | 2,6-octadien-1-ol formate; 3,7-dimethyl-(2E) |
| 27 | 3.8 | 2,6-octadienal; 3,7-dimethyl-(2E) |
| 28 | 3.5 | 2-butanone; 4-(2,6,6-trimethyl-1-cyclohexen-1-yl)- |
| 29 | 2.4 | 2-buten-1-ol acetate; 3-methyl- |
| 30 | 4.2 | 2-buten-1-one; 1-(2,6,6-trimethyl-1-cyclohexen-1-yl)-(E) |
| 31 | 3.4 | 2-buten-1-one; 1-(2,6,6,-trimethyl-3-cyclohexen-1-yl)-(E) |
| 32 | 2.9 | 2-cyclopenten-1-one; 3-methyl-2-(2-pentenyl)-(Z) |
| 33 | 2.9 | 2-decenal (2E) |
| 34 | 2.9 | 2H-1-benzopyran-2-one |
| 35 | 2.3 | 2-heptanol; 2,6-dimethyl- |
| 36 | 4.0 | 2-hexenal (2E) |
| 37 | 2.3 | 2H-pyran; 2-butyl-3,6-dihydro-4,6-dimethyl- |
| 38 | 3.3 | 2-naphthalenol; 1,2,3,4,4a,5,6,7-octahydro-2,6,6- |
| | | trimethyl- |
| 39 | 2.9 | 2-nonene nitrile (2E) |
| 40 | 2.6 | 2-octanol; 2,6-dimethyl- |
| 41 | 2.5 | 2-octanone |
| 42 | 2.7 | 2-pentenoic acid; 2-methyl- |
| 43 | 2.9 | 2-phenylethanol |
| 44 | 2.9 | 2-propen-1-ol; 3-phenyl-(E) |
| 45 | 2.4 | 2-propenal; 2-methyl-3-phenyl-(E) |
| 46 | 2.8 | 2-propenal; 3-phenyl-(E) |
| 47 | 2.9 | 2-propenoic acid phenyl methyl ester; 3-phenyl- |
| 48 | 3.4 | 2-tridecenal (2E) |
| 49 | 3.0 | 2-tridecene nitrile (2Z) |
| 50 | 3.2 | 3,6-nonadiene nitrile; 3,7-dimethyl- |
| 51 | 3.4 | 3-buten-2-one; 1-(2,4,4-trimethyl-2-cyclohexen-1-yl)-(2E) |
| 52 | 3.5 | 3-buten-2-one; 3-methyl-4-(2,6,6-trimethyl-2-cyclohexen- |
| | | 1-yl)- |
| 53 | 2.7 | 3-buten-2-one; 4-(2,6,6-trimethyl-1-cyclohexen-1-yl)- |
| 54 | 2.3 | 3-cyclohexene-1-carbaldehyde; 2,4,6-trimethyl- |
| 55 | 3.4 | 3-cyclohexene-1-carbaldehyde; 2,4-dimethyl-(Z) |
| 56 | 2.3 | 3-cyclohexene-1-carbaldehyde; 3-(4-methyl-3-pentenyl)- |
| 57 | 2.4 | 3-cyclohexene-1-carbaldehyde; 4-(4-hydroxy-4- |
| | | methylpentyl)- |
| 58 | 2.3 | 3-cyclohexene-1-methanol acetate; alpha,alpha-4- |
| | | trimethyl- |
| 59 | 3.3 | 3-hexen-1-ol (3E) |
| 60 | 2.9 | 3-hexen-1-ol (3Z) |
| 61 | 3.6 | 2-octanol; 2,6-dimethyl- |
| 62 | 3.0 | 3-octanol; 3,7-dimethyl- |
| 63 | 3.0 | 4,7-methano-1H-indene-2,5-dimethanol; octahydro- |
| 64 | 3.2 | 4-decenal (4Z) |
| 65 | 2.5 | 4H-4a,9-methanoazuleno[5,6-d]-1,3-dioxole; octahydro- |
| | | 2,2,5,8,8,9a-hexamethyl- |
| 66 | 3.5 | 5,9-undecadienal; 2,6,10-trimethyl- |
| 67 | 4.4 | 6-octen-1-ol; 3,7-dimethyl- |
| 68 | 3.3 | 6-octen-3-one; 2,4,4,7-tetramethyl- |
| 69 | 4.7 | 6-octenal; 3,7-dimethyl- |
| 70 | 4.0 | 6-octene nitrile; 3,7-dimethyl- |
| 71 | 3.2 | 7-octen-2-ol; 2,6-dimethyl- |
| 72 | 3.2 | 9-undecenal (9E) |
| 73 | 3.3 | 9-undecenal (9Z) |
| 74 | 2.9 | 9-undecenal; 2,6,10-trimethyl- |
| 75 | 3.9 | acetaldehyde; [(3,7-dimethyl-6-octenyl)oxy]- |
| 76 | 3.5 | benzaldehyde; 4-(1-methylethyl)- |
| 77 | 4.9 | benzaldehyde; 4-methyl- |
| 78 | 3.2 | benzoic acid 2-methylpropyl ester; 2-hydroxy- |
| 79 | 2.9 | benzoic acid 3-methylbutyl ester |
| 80 | 3.5 | benzoic acid ethyl ester |
| 81 | 3.3 | benzoic acid methyl ester; 2-(methylamino)- |
| 82 | 2.3 | benzoic acid n-pentyl ester, 2-hydroxy |
| 83 | 2.7 | benzoic acid n-propyl ester |
| 84 | 3.8 | benzene; (2,2-dimethoxyethyl)- |
| 85 | 3.5 | benzene; 1-(1,1-dimethylethyl)-3,5-dimethyl-2,4,6-trinitro- |
| 86 | 2.5 | benzene; 1,1′-methylenebis- |
| 87 | 3.2 | benzene; 1,4-dimethoxy- |
| 88 | 2.5 | bicyclo[2,2,1]heptane; 2,2-dimethyl-3-methylene- |
| 89 | 2.3 | bicyclo[2,2,1]heptan-2-ol; 1,3,3-trimethyl- |
| 90 | 2.9 | bicyclo[2,2,1]heptan-2-ol; 1,7,7-trimethyl- |
| 91 | 2.7 | bicyclo[3,1,1]hept-2-ene; 2,6,6-trimethyl- |
| 92 | 3.2 | butyric acid 2-phenylethyl ester; 3-methyl- |
| 93 | 2.5 | butyric acid 3-methylbutyl ester; 3-methyl- |
| 94 | 3.4 | butyric acid n-butyl ester |
| 95 | 2.3 | butyric acid cyclohexyl ester |
| 96 | 2.8 | butyric acid ethyl ester |
| 97 | 2.7 | butyric acid ethyl ester; 2-methyl- |
| 98 | 2.8 | butyric acid ethyl ester; 3-oxo- |
| 99 | 2.5 | quinoline; 6-(1-methylpropyl)- |
| 100 | 2.7 | cyclohexaneethanol acetate |
| 101 | 2.3 | cyclohexanol; 5-methyl-2-(1-methylethyl)- |
| 102 | 2.5 | cyclohexanol; 5-methyl-2-(1-methylethyl)- |
| 103 | 3.7 | cyclohexanol acetate |
| 104 | 2.9 | cyclohexanol acetate; 5-methyl-2-(1-methylethyl)- |
| 105 | 2.9 | cyclohexanone; 5-methyl-2-(1-methylethyl)-(iso) |
| 106 | 3.8 | cyclohexanone; 5-methyl-2-(1-methylethyl)-(L) |
| 107 | 4.7 | cyclohexanepropionic acid 2-propenyl ester |
| 108 | 3.0 | cyclohexene; 1-methyl-4-(1-methylethylidene)- |
| 109 | 3.0 | cyclopentaneacetic acid methyl ester; 3-oxo-2-pentyl-(E) |
| 110 | 4.7 | decanal |
| 111 | 3.3 | decanal; 2-methyl- |
| 112 | 3.0 | dodecanal |
| 113 | 3.4 | acetic acid 2-phenylethyl ester |
| 114 | 3.0 | acetic acid 2-propenyl ester; (cyclohexyloxy)- |
| 115 | 3.3 | acetic acid 2-propenyl ester; 2-(3-methylbutoxy)- |
| 116 | 4.2 | acetic acid 2-propenyl ester; phenoxy- |
| 117 | 3.6 | ethanone; 1-(1,2,3,4,5,6,7,8-octahydro-2,3,8,8- |
| | | tetramethyl-2-naphthalenyl)- |
| 118 | 2.5 | ethanone; 1-(2,3,4,7,8,8a-hexahydro-3,6,8,8-tetramethyl- |
| | | 1H-3a,7-methanoazulen-5-yl)- |
| 119 | 2.4 | ethanone; 1-(2-naphthalenyl)- |
| 120 | 3.7 | ethanone; 1-(2-pyrazinyl)- |
| 121 | 3.8 | ethanone; 1-(4-methylphenyl)- |
| 122 | 2.6 | ethanethioic acid S-[1-[2-(acetyloxy)ethyl]butyl] ester |
| 123 | 4.0 | heptanal |
| 124 | 3.0 | heptanoic acid ethyl ester |
| 125 | 2.9 | hexanal |
| 126 | 3.5 | hexanal; 3,5,5-trimethyl- |
| 127 | 3.0 | indeno[1,2-d]-1,3-dioxine; 4,4a,5,9b-tetrahydro- |
| 128 | 2.7 | indeno[1,2d]-1,3-dioxine; 4,4a,5,9b-tetrahydro-2,4- |
| | | dimethyl- |
| 129 | 2.7 | methanone; diphenyl- |
| 130 | 3.3 | nonanal |
| 131 | 3.5 | octanal |
| 132 | 2.9 | octanoic acid ethyl ester |
| 133 | 3.5 | phenol; 2-methoxy-4-(2-propenyl)- |
| 134 | 3.5 | phenylacetaldehyde |
| 135 | 3.0 | phenylacetaldehyde; alpha-methyl- |
| 136 | 3.3 | phenylacetonitrile; alpha-cyclohexylidene- |
| 137 | 2.7 | phenylacetic acid 2-methylpropyl ester |
| 138 | 2.9 | phenylmethanol acetate; alpha-methyl- |
| 139 | 2.5 | propanedioic acid diethyl ester |
| 140 | 2.4 | propionic acid 2-phenoxyethyl ester; 2-methyl- |
| 141 | 3.3 | propionic acid hexyl ester; 2-methyl- |
| 142 | 2.7 | pyrazine; 2-ethoxy-1-(1-methylethyl)- |
| 143 | 3.3 | pyridine; 2-(3-phenylpropyl)- |
| 144 | 3.2 | pyridine; 4-(4,8-dimethyl-3,7-nonadienyl)- |
| 145 | 4.2 | thiobutyric acid 1-methylpropyl ester; 3-methyl- |
| 146 | 3.3 | undecanal |
| 147 | 2.7 | undecanal; 2-methyl- |
| 148 | | 2H-1,5-benzodioxepin-3(4H)-one; 7-methyl- |
| 149 | | 2,6-octadiene nitrile; 3,7-dimethyl-(2Z) |
| 150 | | 2,6-octadiene nitrile; 3,7-dimethyl-(2E) |
| 151 | | 5-heptenal; 2,6-dimethyl- |
| 152 | | 2(3H)-furanone; 5-butyl-tetrahydro- |
| 153 | | butyric acid ethyl ester; 3-methyl- |
| 154 | | 1,6-octadien-3-ol; 3,7-dimethyl- |
| 155 | | pentanoic acid ethyl ester; 2-methyl- |
| 156 | | 2-propenoic acid ethyl ester; 3-phenyl-(E) |

TABLE 2
Examples of odoriferous substances exhibiting inadequate
odor-reducing action against mineral oil odor

| Name | Reduction value |
|---|---|
| 1-hexanol | 1.2 |
| 1-hexanol acetate; 3,5,5-trimethyl- | 1.0 |
| 1H-indene | 0.4 |
| 1-propan-1-ol acetate | 1.0 |
| 1-propanol; 3-(3-methoxypropoxy)- | 0.8 |
| 2-butanone; 4-(4-hydroxyphenyl)- | 0.9 |
| 2-propanol; 2-methyl-1-phenyl | 1.0 |
| 3-heptanone; 5-methyl- | 0.9 |
| 3-hepten-2-one; 3,4,5,6,6-pentamethyl- | 1.0 |
| 3-hexene; 1-(methoxypropoxy)-(3E) | 0.9 |
| 3-octanol acetate; 3,7-dimethyl- | 1.0 |
| 5-hepten-2-one; 6-methyl- | 1.1 |
| benzoic acid hexyl ester | 1.0 |
| bicyclo[2,2,1]heptan-2-ol acetate; 1,7,7-trimethyl | 0.8 |
| bicyclo[3,1,1]heptane; 6,6-dimethyl-2-methylene- | 0.5 |
| dipropylene glycol | −0.4 |
| acetic acid benzyl ester | 1.2 |
| acetic acid n-butyl ester | 0.6 |
| acetic acid ethyl ester | 0.5 |
| acetic acid n-heptyl ester | 1.0 |
| acetic acid n-pentyl ester | −0.2 |
| heptanoic acid 2-propenyl ester | 1.0 |
| hexanoic acid methyl ester | 0.7 |

### Example 2

### Testing of Mixtures/Combinations Against Heating Oil Odor

3 mixtures (A-C) were produced using the following formulations:

| | | |
|---|---|---|
| | Re- | |
| | duction | |
| Name | value | Quantity/g |

Mixture A:

| | | |
|---|---|---|
| 2,2-dimethylpropanal; 3-(4-ethylphenyl)- | 2.7 | 6.50 |
| 3-buten-2-one; 1-(2,4,4-trimethyl-2-cyclo-hexen-1- | 3.4 | 10.00 |
| yl)-(2E) | | |
| indeno[1,2d]-1,3-dioxine; 4,4a,5,9b-tetrahydro-2,4- | 2.7 | 7.00 |
| dimethyl- | | |
| indeno[1,2-d]-1,3-dioxine; 4,4a,5,9b-tetrahydro- | 3.0 | 9.50 |
| 1,3-dioxane; 2,4,6-trimethyl-4-phenyl- | 2.5 | 8.00 |
| 4H-4a,9-methanoazuleno[5,6-d]-1,3-dioxole; | 2.5 | 2.00 |
| octahydro-2,2,5,8,8,9a-hexamethyl- | | |
| (4aR;5R;7aS;9R) | | |
| 5,9-undecadienal; 2,6,10-trimethyl- | 3.5 | 12.00 |
| 2-(2-ethoxyethoxy)ethanol | | 45.00 |

Mixture B:

| | | |
|---|---|---|
| phenylacetaldehyde | 3.5 | 2.75 |
| cyclohexanone; 5-methyl-2-(1-methylethyl)-(L) | 2.9 | 4.50 |
| 2-hexenal (2E) | 4.0 | 9.25 |
| 2(3H)-furanone; 4-hydroxy-2,5-dimethyl- | 3.9 | 16.00 |
| 2,6-nonadienal (2E,6Z) | 3.5 | 20.00 |
| 6-octenal; 3,7-dimethyl- | 4.7 | 7.00 |
| 3-buten-2-one; 3-methyl-4-(2,6,6-trimethyl-2- | 3.5 | 2.50 |
| cyclohexen-1-yl)- | | |
| 2-buten-1-one; 1-(2,6,6-trimethyl-1-cyclohexen-1- | 3.4 | 17.00 |
| yl)-(E) | | |
| 2-butanone; 4-(2,6,6-trimethyl-1-cyclohexen-1-yl)- | 3.5 | 16.00 |
| 2-(2-ethoxyethoxy)ethanol | | 5.00 |

Mixture C:

| | | |
|---|---|---|
| pyridine; 2-(3-phenylpropyl)- | 3.3 | 16.50 |
| 2-tridecenal (2E) | 3.4 | 4.50 |
| 2(3H)-furanone; 4-hydroxy-2,5-dimethyl- | 3.9 | 16.00 |
| 2.6-nonadienal (2E,6Z) | 3.5 | 2.50 |
| 2,6-octadienal; 3,7-dimethyl-(2E) | 3.8 | 4.00 |
| 2-buten-1-one; 1-(2,6,6-trimethyl-3-cyclohexen-1- | 4.2 | 15.00 |
| yl)-(E) | | |
| 6-octen-3-one; 2,4,4,7-tetramethyl- | 3.3 | 4.50 |
| 5,9-undecadienal; 2,6,10-trimethyl- | 3.5 | 17.00 |
| 2-(2-ethoxyethoxy)ethanol | | 20.00 |

Mixtures A-C were tested using the above-stated method in comparison with 4,4a,5,9b-tetrahydro-indeno[1,2-d]-1,3-dioxine, 1-methyl-4-(1-methylethenyl)-cyclohexene and 2-(2-ethoxyethoxy)ethanol. The mixtures have the desired action. It proved possible to replicate the values for the individual substances.

TABLE 4
Results of testing with the mixtures

| NAME | Reduction value |
|---|---|
| MIXTURE A | 3.6 |
| MIXTURE B | 4.1 |
| MIXTURE C | 3.9 |
| indeno[1,2-d]-1,3-dioxine, 4,4a,5,9b-tetrahydro- | 3.2 |
| cyclohexene, 1-methyl-4-(1-methylethenyl)- | 0.5 |
| 2-(2-ethoxyethoxy)ethanol | 0.2 |

Mixtures A-C were also tested at a rate of addition of 50 ppm in heating oil using the above-stated method in comparison with 4,4a,5,9b-tetrahydro-indeno[1,2-d]-1,3-dioxine, 1-methyl-4-(1-methylethenyl)-cyclohexene and }2-(2-ethoxyethoxy)ethanol. To this end, the perfuming compositions were stirred into the heating oil at this rate of addition. 10 g portions of the heating oil perfumed in this manner were placed 30 ml screw-top jars. The samples were evaluated in comparison with unperfumed heating oil using the same scale as in the above-stated method. In this test too, which is closer to the real-life application of the products, the mixtures have the desired action. Since only a few samples were compared in this manner, neither the personal wellbeing nor the cognitive ability of the testers were impaired. Here too, it proved possible to obtain the effects of the individual substances.

TABLE 5
Results of testing with the direct mixtures of heating oil

| NAME | Reduction value |
|---|---|
| MIXTURE A | 3.5 |
| MIXTURE B | 4.6 |
| MIXTURE C | 4.0 |
| indeno[1,2-d]-1,3-dioxine; 4,4a,5,9b-tetrahydro- | 2.9 |
| cyclohexene, 1-methyl-4-(1-methylethenyl)- | 0.1 |
| 2-(2-ethoxyethoxy)ethanol | 0.3 |

What is claimed is:

1. A mineral oil, characterized in that the mineral oil comprises a proportion of 0.5 ppm to 1.2 wt. %, relative to the entire mineral oil, of one or more odoriferous substances which are selected from group (A) consisting of
1,3-dioxane; 2,4,6-trimethyl-4-phenyl-1,3-dioxolane-2-acetic acid ethyl ester; 2,4-dimethyl-1,3-oxathiane; 2-methyl-4-propyl-(Z)
1-nonyne; 1,1-dimethoxy-1-octanol
2(3H)-furanone; 5-hexyl-dihydro-
2,2-dimethylpropanal; 3-(4-ethylphenyl)-2,4-decadienal (2E,4E)
2,6-nonadienal (2E,6Z)
2,6-octadien-1-ol formate; 3,7-dimethyl-(2E)
2-buten-1-ol acetate; 3-methyl-2-buten-1-one; 1-(2,6,6,-trimethyl-3-cyclohexen-1-yl)-(E)
2-decenal (2E)
2H-pyran; 2-butyl-3,6-dihydro-4,6-dimethyl-2-naphthalenol; 1,2,3,4,4a,5,6,7-octahydro-2,6,6-trimethyl-2-nonene nitrile (2E)
2-tridecenal (2E)
2-tridecene nitrile (2Z)
3,6-nonadiene nitrile; 3,7-dimethyl-3-buten-2-one; 3-methyl-4-(2,6,6-trimethyl-2-cyclohexen-1-yl)-3-cyclohexene-1-carbaldehyde; 2,4,6-trimethyl-3-cyclohexene-1-carbaldehyde; 2,4-dimethyl-(Z)
3-hexen-1-ol (3E)
3-hexen-1-ol (3Z)
3-octanol; 3,7-dimethyl-4-decenal (4Z)
4H-4-a,9-methanoazuleno[5,6-d]-1,3-dioxole; octahydro-2,2,5,8,8,9a-hexamethyl-9-undecenal (9E)
9-undecenal (9Z) 9-undecenal; 2,6,10-trimethyl-benzaldehyde; 4-(1-methylethyl)-bicyclo[2,2,1]heptan-2-ol; 1,3,3-trimethyl-bicyclo[2,2,1]heptan-2-ol; 1,7,7-trimethyl-bicyclo[3,1,1]hept-2-ene; 2,6,6-trimethyl-butyric acid cyclohexyl ester
butyric acid ethyl ester
butyric acid ethyl ester; 2-methyl-quinoline; 6-(1-methylpropyl)-cyclohexanone; 5-methyl-2-(1-methylethyl)-(iso) decanal; 2-methyl-dodecanal
acetic acid 2-propenyl ester; (cyclohexyloxy)-acetic acid 2-propenyl ester; 2-(3-methylbutoxy)-ethanethioic acid S-[1-[2-(acetyloxy)ethyl]butyl]ester
heptanoic acid ethyl ester
hexanal
hexanal; 3,5,5-trimethyl-nonanal
octanal
phenol; 2-methoxy-4-(2-propenyl)-phenylacetaldehyde
phenylacetaldehyde; alpha-methyl-pyrazine; 2-ethoxy-1-(1-methylethyl)-pyridine; 2-(3-phenylpropyl)-pyridine; 4-(4,8-dimethyl-3,7-nonadienyl)-undecanal
undecanal; 2-methyl-1,3,5-trioxane; 2,4,6-trimethyl-1-butanol acetate; 3-methyl-2(3H)-furanone; 4-hydroxy-2,5-dimethyl-2(3H)-furanone; dihydro-5-pentyl-2,6-octadien-1-ol; 3,7-dimethyl-(2E)
2,6-octadienal; 3,7-dimethyl-(2E)
2-buten-1-one; 1-(2,6,6-trimethyl-1-cyclohexen-1-yl)-(E)
2-hexenal (2E)
6-octen-1-ol; 3,7-dimethyl-6-octenal; 3,7-dimethyl-6-octene nitrile; 3,7-dimethyl-acetaldehyde; [(3,7-dimethyl-6-octenyl)oxy]-benzaldehyde; 4-methyl-benzene; (2,2-dimethoxyethyl)-cyclohexanol acetate
cyclohexanone; 5-methyl-2-(1-methylethyl)-(L)
cyclohexanepropionic acid 2-propenyl ester
decanal
acetic acid 2-propenyl ester; phenoxy-ethanone; 1-(1,2,3,4,5,6,7,8-octahydro-2,3,8,8-tetramethyl-2-naphthalenyl)-ethanone; 1-(2-pyrazinyl)-ethanone; 1-(4-methylphenyl)-heptanal
thiobutyric acid 1-methylpropyl ester; 3-methyl-2H-1,5-benzodioxepin-3(4H)-one; 7-methyl-2,6-octadiene nitrile; 3,7-dimethyl-(2Z)
2,6-octadiene nitrile; 3,7-dimethyl-(2E)
5-heptenal; 2,6-dimethyl-2(3H)-furanone; 5-butyl-tetrahydro-butyric acid ethyl ester; 3-methyl-1,6-octadien-3-ol; 3,7-dimethyl-pentanoic acid ethyl ester; 2-methyl-2-propenoic acid ethyl ester; 3-phenyl-(E)
1,2,3,4,4a,9,10,10a-octahydro-phenanthrene-1-carboxylic acid methyl ester; 7-isopropyl-1,4-a-dimethyl-1,3-benzodioxolane-5-propanal; alpha-methyl-1,3-dioxolane-2-acetic acid ethyl ester; 2-methyl-10-undecenal
1-decanol
1H-4,7-methanoinden-5-ol propionate; 3a,4,5,6,7,7a-hexahydro-
1-hexanol; 3,5,5-trimethyl-1-octen-3-ol acetate
2(3H)-furanone; 5-heptyl-dihydro-2,6-octadien-1-ol acetate; 3,7-dimethyl-(2E)
2,6-octadien-1-ol acetate; 3,7-dimethyl-(2Z)
2-butanone; 4-(2,6,6-trimethyl-1-cyclohexen-1-yl)-2-cyclopenten-1-one; 3-methyl-2-(2-pentenyl)-(Z)
2H-1-benzopyran-2-one
2-heptanol; 2,6-dimethyl-2-octanol; 2,6-dimethyl-2-octanone
2-pentenoic acid; 2-methyl-2-phenylethanol
2-propen-1-ol; 3-phenyl-(E)
2-propenal; 2-methyl-3-phenyl-(E)
2-propenal; 3-phenyl-(E)
2-propenoic acid phenyl methyl ester; 3-phenyl-3-buten-2-one; 1-(2,4,4-trimethyl-2-cyclohexen-1-yl)-(2E)
3-buten-2-one; 4-(2,6,6-trimethyl-1-cyclohexen-1-yl)-3-cyclohexene-1-carbaldehyde; 3-(4-methyl-3-pentenyl)-3-cyclohexene-1-carbaldehyde; 4-(4-hydroxy-4-methylpentyl)-3-cyclohexene-1-methanol acetate; alpha,alpha-4-trimethyl-2-octanol; 2,6-dimethyl-4,7-methano-1H-indene-2,5-dimethanol; octahydro-5,9-undecadienal; 2,6,10-trimethyl-6-octen-3-one; 2,4,4,7-tetramethyl-7-octen-2-ol; 2,6-dimethyl-benzoic acid 2-methylpropyl ester; 2-hydroxy-benzoic acid 3-methylbutyl ester
benzoic acid ethyl ester
benzoic acid methyl ester; 2-(methylamino)-benzoic acid n-pentyl ester, 2-hydroxy
benzoic acid n-propyl ester
benzene; 1-(1,1-dimethylethyl)-3,5-dimethyl-2,4,6-trinitro-benzene; 1,1′-methylenebis-benzene; 1,4-dimethoxy-bicyclo[2,2,1]heptane; 2,2-dimethyl-3-methylene-butyric acid 2-phenylethyl ester; 3-methyl-butyric acid 3-methylbutyl ester; 3-methyl-butyric acid n-butyl ester
butyric acid ethyl ester; 3-oxo-cyclohexaneethanol acetate
cyclohexanol; 5-methyl-2-(1-methylethyl)-cyclohexanol; 5-methyl-2-(1-methylethyl)-cyclohexanol acetate; 5-methyl-2-(1-methylethyl)-cyclohexene; 1-methyl-4-(1-methylethylidene)-cyclopentaneacetic acid methyl ester; 3-oxo-2-pentyl-(E)
acetic acid 2-phenylethyl ester
ethanone; 1-(2,3,4,7,8,8a-hexahydro-3,6,8,8-tetramethyl-1H-3a,7-methanoazulen-5-yl)-ethanone; 1-(2-naphthalenyl)-indeno[1,2-d]-1,3-dioxine; 4,4a,5,9b-tetrahydro-indeno[1,2-d]-1,3-dioxine; 4,4a,5,9b-tetrahydro-2,4-dimethyl-methanone; diphenyl-octanoic acid ethyl ester
phenylacetonitrile; alpha-cyclohexylidene-phenylacetic acid 2-methylpropyl ester
phenylmethanol acetate; alpha-methyl-propanedioic acid diethyl ester
propionic acid 2-phenoxyethyl ester; 2-methyl-propionic acid hexyl ester; 2-methyl-.

2. The mineral oil as claimed in claim 1, wherein the content of odoriferous substances of group (A)
a) is 1 to 1000 ppm, preferably 10-500 ppm, and particularly preferably 30-300 ppm, relative to the entire mineral oil, if the mineral oil is a heating oil, diesel or gasoline, and
b) is 0.01-2 wt. %, preferably 0.1-2 wt. %, and particularly preferably 0.2-2 wt. %, relative to the entire mineral oil, if the mineral oil is a lubricant oil.

3. The mineral oil as claimed in claim 1, characterized in that at least one of the odoriferous substance(s) of group (A) is selected from the group (B), consisting of:
1,3,5-trioxane; 2,4,6-trimethyl-1-butanol acetate; 3-methyl-2(3H)-furanone; 4-hydroxy-2,5-dimethyl-2(3H)-furanone; dihydro-5-pentyl-2,6-octadien-1-ol; 3,7-dimethyl-(2E)
2,6-octadienal; 3,7-dimethyl-(2E)
2-buten-1-one; 1-(2,6,6-trimethyl-1-cyclohexen-1-yl)-(E)
2-hexenal (2E)
6-octen-1-ol; 3,7-dimethyl-6-octenal; 3,7-dimethyl-6-octene nitrile; 3,7-dimethyl-acetaldehyde; [(3,7-dimethyl-6-octenyl)oxy]-benzaldehyde; 4-methyl-benzene; (2,2-dimethoxyethyl)-cyclohexanol acetate
cyclohexanone; 5-methyl-2-(1-methylethyl)-(L)
cyclohexanepropionic acid 2-propenyl ester
decanal
acetic acid 2-propenyl ester; phenoxy-ethanone; 1-(1,2,3,4,5,6,7,8-octahydro-2,3,8,8-tetramethyl-2-naphthalenyl)-ethanone; 1-(2-pyrazinyl)-ethanone; 1-(4-methylphenyl)-heptanal
thiobutyric acid 1-methylpropyl ester; 3-methyl-2H-1,5-benzodioxepin-3(4H)-one; 7-methyl-2,6-octadiene nitrile; 3,7-dimethyl-(2Z)
2,6-octadiene nitrile; 3,7-dimethyl-(2E)
5-heptenal; 2,6-dimethyl-2(3H)-furanone; 5-butyl-tetrahydro-butyric acid ethyl ester; 3-methyl-1,6-octadien-3-ol; 3,7-dimethyl-pentanoic acid ethyl ester; 2-methyl-2-propenoic acid ethyl ester; 3-phenyl-(E).

4. The mineral oil as claimed in claim 3, wherein at least one of the odoriferous substances of group (A) is selected from the group (C) consisting of
1,3-dioxane; 2,4,6-trimethyl-4-phenyl-
1,3-dioxolane-2-acetic acid ethyl ester; 2,4-dimethyl-1,3-oxathiane; 2-methyl-4-propyl-(Z)
1-nonyne; 1,1-dimethoxy-1-octanol
2(3H)-furanone; 5-hexyl-dihydro-2,2-dimethylpropanal; 3-(4-ethylphenyl)-2,4-decadienal (2E,4E)
2,6-nonadienal (2E,6Z)
2,6-octadien-1-ol formate; 3,7-dimethyl-(2E)
2-buten-1-ol acetate; 3-methyl-2-buten-1-one; 1-(2,6,6,-trimethyl-3-cyclohexen-1-yl)-(E)
2-decenal (2E)
2H-pyran; 2-butyl-3,6-dihydro-4,6-dimethyl-2-naphthalenol; 1,2,3,4,4a,5,6,7-octahydro-2,6,6-trimethyl-2-nonene nitrile (2E)
2-tridecenal (2E)
2-tridecene nitrile (2Z)
3,6-nonadiene nitrile; 3,7-dimethyl-3-buten-2-one; 3-methyl-4-(2,6,6-trimethyl-2-cyclohexen-1-yl)-3-cyclohexene-1-carbaldehyde; 2,4,6-trimethyl-3-cyclohexene-1-carbaldehyde; 2,4-dimethyl-(Z)
3-hexen-1-ol (3E)
3-hexen-1-ol (3Z)
3-octanol; 3,7-dimethyl-4-decenal (4Z)
4H-4-a,9-methanoazuleno[5,6-d]-1,3-dioxole; octahydro-2,2,5,8,8,9a-hexamethyl-9-undecenal (9E)
9-undecenal (9Z)
9-undecenal; 2,6,10-trimethyl-benzaldehyde; 4-(1-methylethyl)-bicyclo[2,2,1]heptan-2-ol; 1,3,3-trimethyl-bicyclo[2,2,1]heptan-2-ol; 1,7,7-trimethyl-bicyclo[3,1,1]hept-2-ene; 2,6,6-trimethyl-butyric acid cyclohexyl ester
butyric acid ethyl ester
butyric acid ethyl ester; 2-methyl-quinoline; 6-(1-methylpropyl)-cyclohexanone; 5-methyl-2-(1-methylethyl)-(iso)
decanal; 2-methyl-dodecanal
acetic acid 2-propenyl ester; (cyclohexyloxy)-acetic acid 2-propenyl ester; 2-(3-methylbutoxy)-ethanethioic acid S-[1-[2-(acetyloxy)ethyl]butyl]ester
heptanoic acid ethyl ester
hexanal
hexanal; 3,5,5-trimethyl-nonanal
octanal
phenol; 2-methoxy-4-(2-propenyl)-phenylacetaldehyde
phenylacetaldehyde; alpha-methyl-pyrazine; 2-ethoxy-1-(1-methylethyl)-pyridine; 2-(3-phenylpropyl)-pyridine; 4-(4,8-dimethyl-3,7-nonadienyl)-undecanal
undecanal; 2-methyl-.

5. The mineral oil as claimed in claim 4, wherein at least one of the odoriferous substances of group (A) is selected from group (B) and at least one of the odoriferous substances of group (A) is selected from group (C) and/or at least one of the odoriferous substances of group (A) is selected from group (D), consisting of
1,2,3,4,4a,9,10,10a-octahydro-phenanthrene-1-carboxylic acid methyl ester;
7-isopropyl-1,4a-dimethyl-1,3-benzodioxolane-5-propanal; alpha-methyl-1,3-dioxolane-2-acetic acid ethyl ester; 2-methyl-10-undecenal
1-decanol
1H-4,7-methanoinden-5-ol propionate; 3a,4,5,6,7,7a-hexahydro-1-hexanol; 3,5,5-trimethyl-1-octen-3-ol acetate
2(3H)-furanone; 5-heptyl-dihydro-2,6-octadien-1-ol acetate; 3,7-dimethyl-(2E)
2,6-octadien-1-ol acetate; 3,7-dimethyl-(2Z)
2-butanone; 4-(2,6,6-trimethyl-1-cyclohexen-1-yl)-2-cyclopenten-1-one; 3-methyl-2-(2-pentenyl)-(Z)
2H-1-benzopyran-2-one
2-heptanol; 2,6-dimethyl-2-octanol; 2,6-dimethyl-2-octanone
2-pentenoic acid; 2-methyl-2-phenylethanol
2-propen-1-ol; 3-phenyl-(E)
2-propenal; 2-methyl-3-phenyl-(E)
2-propenal; 3-phenyl-(E)
2-propenoic acid phenyl methyl ester; 3-phenyl-3-buten-2-one; 1-(2,4,4-trimethyl-2-cyclohexen-1-yl)-(2E)
3-buten-2-one; 4-(2,6,6-trimethyl-1-cyclohexen-1-yl)-3-cyclohexene-1-carbaldehyde; 3-(4-methyl-3-pentenyl)-3-cyclohexene-1-carbaldehyde; 4-(4-hydroxy-4-methylpentyl)-3-cyclohexene-1-methanol acetate; alpha,alpha-4-trimethyl-2-octanol; 2,6-dimethyl-4,7-methano-1H-indene-2,5-dimethanol; octahydro-5,9-undecadienal; 2,6,10-trimethyl-6-octen-3-one; 2,4,4,7-tetramethyl-7-octen-2-ol; 2,6-dimethyl-benzoic acid 2-methylpropyl ester; 2-hydroxy-benzoic acid 3-methylbutyl ester
benzoic acid ethyl ester
benzoic acid methyl ester; 2-(methylamino)-benzoic acid n-pentyl ester, 2-hydroxy
benzoic acid n-propyl ester
benzene; 1-(1,1-dimethylethyl)-3,5-dimethyl-2,4,6-trinitro-benzene; 1,1′-methylenebis-benzene; 1,4-dimethoxy-bicyclo[2,2,1]heptane; 2,2-dimethyl-3-methylene-butyric acid 2-phenylethyl ester; 3-methyl-butyric acid 3-methylbutyl ester; 3-methyl-butyric acid n-butyl ester
butyric acid ethyl ester; 3-oxo-cyclohexaneethanol acetate
cyclohexanol; 5-methyl-2-(1-methylethyl)-cyclohexanol; 5-methyl-2-(1-methylethyl)-cyclohexanol acetate; 5-methyl-2-(1-methylethyl)-cyclohexene; 1-methyl-4-(1-methylethylidene)-cyclopentaneacetic acid methyl ester; 3-oxo-2-pentyl-(E)
acetic acid 2-phenylethyl ester
ethanone; 1-(2,3,4,7,8,8a-hexahydro-3,6,8,8-tetramethyl-1H-3a,7-methanoazulen-5-yl)-ethanone; 1-(2-naphthalenyl)-indeno[1,2-d]-1,3-dioxine; 4,4a,5,9b-tetrahydro-indeno[1,2-d]-1,3-dioxine; 4,4a,5,9b-tetrahydro-2,4-dimethyl-methanone; diphenyl-octanoic acid ethyl ester
phenylacetonitrile; alpha-cyclohexylidene-phenylacetic acid 2-methylpropyl ester
phenylmethanol acetate; alpha-methyl-propanedioic acid diethyl ester
propionic acid 2-phenoxyethyl ester; 2-methyl-propionic acid hexyl ester; 2-methyl-.

6. The mineral oil as claimed in claim 5, wherein at least one of the odoriferous substances of group (A) is selected from group (B) and at least one of the odoriferous substances of group (A) is selected from group (C) and at least one of the odoriferous substances of group (A) is selected from group (D).

7. The mineral oil as claimed in claim 1, wherein in addition to the odoriferous substance(s) of group (A), the mineral oil comprises at least one additive constituent which is selected from: a flow promoter, a filterability improver, a metal deactivator, an antioxidant, a corrosion inhibitor, an antifoam agent, an ignition accelerator, a detergent, a particulate-reducing substance, a stabilizer, an antiknock agent, a carburetor antiicing additive, an antideposition agent, an antismoke agent, a biocide, a lubricity improver, a conductivity improver, an antiwear agent, a dye, a color stabilizer and a viscosity improver.

8. The mineral oil as claimed in claim 1, wherein the mineral oil comprises a proportion of 90 wt. %, preferably 95-99.9 wt. %, of a heating oil EL to DIN 51603, a heating oil to DIN 51601 part 1 and/or a diesel fuel to DIN EN 590.

9. An additive for fragrancing a mineral oil comprising a content of odoriferous substances, the additive comprising one or more odoriferous substances of group (A) of claim 5 in a proportion of at least 55 wt. % relative to the total mass of odoriferous substances.

10. The additive as claimed in claim 9, wherein one or more of the odoriferous substances of group (A) being selected from group (B), and one or more of the odoriferous substances of group (A) being selected from group (C) and/or group (D).

11. Use of an odoriferous substance selected from group (A) or group (B) of claim 3,
for reducing, masking or suppressing the stench of a mineral oil, or
for producing an additive for reducing, masking or suppressing the stench of a mineral oil.

12. Use of a mixture containing an odoriferous substance of group (B) and an odoriferous substance of group (C) and/or an odoriferous substance of group (D) of claim 5,
for reducing, masking or suppressing the stench of a mineral oil or
for producing an additive for reducing, masking or suppressing the stench of a mineral oil.

13. Use of an additive as claimed in claim 9 for reducing, masking or suppressing the stench of a mineral oil.

14. Use as claimed in claim 11, the stench of the mineral oil being the stench of a heating oil EL to DIN 51603, a heating oil to DIN 51601 part 1 and/or a diesel fuel to DIN EN 590.

15. A method for reducing, masking or suppressing the stench of a mineral oil comprising the steps:
a) providing a mineral oil to be treated, and
b) adding an additive as claimed in claim 9 to the mineral oil until a desired reduction, masking or suppression of the stench is achieved.

16. A method for reducing, masking or suppressing the stench of a mineral oil comprising the steps:
a) providing a mineral oil to be treated, and
b) adding an additive as claimed in claim 10 to the mineral oil until a desired reduction, masking or suppression of the stench is achieved.

17. The mineral oil as claimed in claim 3, wherein the content of odoriferous substances of group (A)
a) is 1 to 1000 ppm, preferably 10-500 ppm, and particularly preferably 30-300 ppm, relative to the entire mineral oil, if the mineral oil is a heating oil, diesel or gasoline, and
b) is 0.01-2 wt. %, preferably 0.1-2 wt. %, and particularly preferably 0.2-2 wt. %, relative to the entire mineral oil, if the mineral oil is a lubricant oil.

18. Use of an additive of claim 10, for reducing, mashing or suppressing the stench of a mineral oil.

19. Use as claimed in claim 12, the stench of the mineral oil being the stench of a heating oil EL to DIN 51603, a heating oil to DIN 51601 part 1 and/or a diesel fuel to DIN EN 590.

20. Use as claimed in claim 13, the stench of the mineral oil being the stench of a heating oil EL to DIN 51603, a heating oil to DIN 51601 part 1 and/or a diesel fuel to DIN EN 590.
